(19) United States
(12) Patent Application Publication
(10) Pub. No.: US 2014/0134590 A1
(43) Pub. Date: May 15, 2014

(54) Progress Tracking And Management System

(71) Applicant: Steven Richard Hiscock Jr., Redding, CA (US)

(72) Inventor: Steven Richard Hiscock Jr., Redding, CA (US)

(21) Appl. No.: 14/075,043

(22) Filed: Nov. 8, 2013

Related U.S. Application Data
(60) Provisional application No. 61/724,426, filed on Nov. 9, 2012.

(51) Int. Cl. G09B 5/00

(52) U.S. Cl. CPC G09B 5/00
USPC 434/350

(57) ABSTRACT

A computer implemented method and system for tracking and managing progress of performance goals developed by one or more institutions and district administrations at multiple levels is provided. A progress management platform (PMP) accessible via a network, receives goal information and goal criteria at one or more levels and generates one or more modifiable performance goals at those levels. The PMP tracks progress of the generated modifiable performance goals (GMPGs) by collecting and monitoring observations received on execution of the GMPGs by internal entities at one or more levels, self reviews and peer reviews received from the internal entities at one or more levels, feedback received from external entities, etc. The PMP generates one or more progress reports at one or more levels based on the tracked progress of the GMPGs to quantify results of the execution of the GMPGs for facilitating accountability, professional development, and development of improvement programs.

### CROSS REFERENCE TO RELATED APPLICATIONS

This application claims priority to and the benefit of provisional patent application No. 61/724,426 titled “Progress Tracking And Management System”, filed in the United States Patent and Trademark Office on Nov. 9, 2012. The specification of the above referenced patent application is incorporated herein by reference in its entirety.

### BACKGROUND

Providing a culturally healthy and an educative environment to students enrolled in a school is the most important concern of the school. Research conducted by Togneri & Anderson in 2003 showed that “High performing school districts actively seek to establish a clear expectation that the principal will be the instructional leader and the primary architect of instructional improvement at the school”. Hence, the principal becomes the sole bearer of the entire burden of a school's academic performance and social presence. It becomes imperative for the principal to ensure that each member of the staff of the school works diligently and honestly towards developing and maintaining an educationally responsive and culturally healthy environment for the students in the school. According to Doug Reeves “The distinguishing characteristic of the 90/90/90 schools was not merely that they had standards, but rather, how the standards were implemented, monitored, and assessed”. It becomes the responsibility of the principal or a head of an educational institution or a district administrator to employ performance evaluation techniques and tools in the educational institution that aim at achieving an optimal educative environment that benefits a teacher's career as well as a student's academic performance.

In a present day scenario, most principals resort to a walk through to gather classroom information that can help the principal in assessing educational leadership of a teacher in a classroom. The walk through is a form of an audit that is implemented to determine learning and teaching practices in schools and other educational institutions. Typical formal observation procedures used to perform a walk through result in intimidating the teachers and the students. The typical evaluation systems focus on students' performances alone to judge a teacher's performance which proves to be an unfair method of evaluating a teacher's performance. This is an inefficient technique of measuring a teacher's performance as a student's academic performance is not completely affected by knowledge imparted by the teacher in the classroom. A student could perform well in an exam if the student has a favorable environment at home or in a surrounding environment. Similarly, a student may perform poorly in an exam if the conditions are not favorable enough to encourage the student to study. Under such circumstances, the teacher need not be blamed for being inefficient. In such scenarios, these typical evaluation systems fail. There is a need for a progress tracking and management system that can gauge a teacher's performance and dedication to work based on a real time analysis of the teacher's conduct and contributions to classroom activities on various parameters that can be determined, for example, by the teacher, an evaluator, students, or even parents.

Another problem with typical walk through evaluation systems is that they are not adaptable to education methods of an institution. The institution itself has to modify goals and objectives according to policies of the evaluation systems and district administrations. Furthermore, these evaluation systems do not report the level of effort or participation that a teaching staff exhibits in its field of work. Hence, these evaluation systems are unable to provide a correct picture of accountability of teachers for leadership in a classroom. Moreover, these evaluation systems are unable to effectively gauge a student's academic performance or participation of students in classroom activities. Therefore, parents or guardians of a student often do not know why their child may be performing poorly or exceptionally in certain areas, subjects, or classes.

Another disadvantage of typical evaluation systems is that they require manual participation by an evaluator for the execution of evaluation techniques. The entire process of creating and administering an individual education plan for a student in need of special attention is accomplished manually. Essentially, this involves teachers manually completing a myriad of forms for tracking the student's progress. These practices are labor intensive and utilize a large amount of time and energy of the teachers. There is a need for an automated progress tracking and management system that enables the teachers to determine goals and goal criteria for individual students and track progress of the determined goals and goal criteria.

Most performance evaluation systems employed in educational institutions typically focus only on reviewing performance of a few entities of the educational institutions, for example, teaching staff members, a head of a department, etc. These performance evaluation systems do not enable supervising entities to audit the performance of other entities of the educational institutions, for example, a custodian, a maintenance staff member, staff members of a transport department of an educational institution, etc., that are also responsible for maintaining a culturally healthy and educationally progressive environment at the educational institutions. Principals of the educational institutions need to monitor actions and performance of every entity that is part of their educational institutions to ensure growth of the educational institution in all aspects. Moreover, there is a need for a progress tracking and management system that enables supervising entities, for example, peers, superiors, subordinates of an evaluated entity, etc., to perform observations on every entity at multiple levels of an institution or a district administration, thereby ensuring a thorough evaluation of activities conducted by all entities across the institution or the district administration.

Furthermore, the typical walk through evaluation systems fail to elaborately disclose results of evaluations performed by various entities of an institution or a district administration. Evaluation reports are limited to obsolete reporting techniques, for example, a table or a form with predetermined goals set for the evaluations. A supervising entity is unable to evaluate an entity's performance based on goals and/or goal criteria set by the supervising entity or even the entity being evaluated. These reporting techniques limit the scope of progress or improvement in the performance of the evaluated entity as these reporting techniques are unable to substantially gauge the evaluated entity's skills or competency. There is a need for a progress tracking and management system that can quantify results of evaluation of the entities at the institution or the district administration based on multiple modifiable goals.

Hence, there is a long felt but unresolved need for a computer implemented method and system that generates performance goals based on goal criteria, and tracks and manages progress of the performance goals developed by one or more institutions and one or more district administrations at multiple levels, for example, at a district level, an institution level, a department level, a grade level, an individual staff level, etc., to update the current education system, improve professional development, and improve academic performance of students. Moreover, there is a need for a computer implemented method and system that can modify the performance goals and objectives to suit the requirements of each institution for evaluation of the performance of multiple entities of the institution. Furthermore, there is a need for a computer implemented method and system that generates reports based on the tracked progress at different levels and provides the generated reports to the concerned entities via multiple communication modes. Furthermore, there is a need for a computer implemented method and system that provides systematic immediate feedback on the performance of multiple entities of the institution, thereby ensuring administrative accountability, and provides a tool for measuring growth of the performance goals that are typically difficult to quantify. Moreover, there is a need for a computer implemented method and system that enables a supervising entity to perform formal and/or informal observations of every entity of an institution or a district administration at multiple levels, thereby ensuring a thorough evaluation of activities conducted by every entity at the institution or the district administration. Furthermore, there is a need for a computer implemented method and system that can quantify results of evaluation of the entities at the institution or the district administration based on multiple goals for facilitating accountability, professional development, and development of improvement programs.

### SUMMARY OF THE INVENTION

This summary is provided to introduce a selection of concepts in a simplified form that are further disclosed in the detailed description of the invention. This summary is not intended to identify key or essential inventive concepts of the claimed subject matter, nor is it intended for determining the scope of the claimed subject matter.

The computer implemented method and system disclosed herein addresses the above stated needs for generating performance goals based on goal criteria, and tracking and managing progress of the performance goals developed by one or more institutions and one or more district administrations at multiple levels, for example, at a district level, an institution level, a department level, a grade level, an individual staff level, etc., to update the current education system, improve professional development, and improve academic performance of students. As used herein, the term “institution” refers to an establishment or an organization working towards a particular cause or a program. The institution is, for example, an educational institution, a medical institution, a financial institution, etc. Also, as used herein, the term “district administration” refers to a monitoring body of persons supervising multiple institutions in a particular geographical location, for example, an administrative division of a city, a county, etc. Also, as used herein, the term “level” refers to a hierarchical position in a system of persons belonging to an institution or a district, who are organized into graded ranks. For example, the levels in an educational system comprise a district administration level for a particular locality or a district, a school level headed by a principal within the district, a staff level comprising teachers, peer coaches, etc., a parental level, a student level, etc.

In addition to helping teachers, the computer implemented method and system disclosed herein helps schools and districts to be efficient and effective in working with their entire staff. The computer implemented method and system disclosed herein enables supervising entities of an institution or a district administration or external entities to perform formal and/or informal observations of every entity of the institution or the district administration at multiple levels, thereby ensuring a thorough evaluation of activities conducted by every entity at the institution or the district administration and ensuring a culturally healthy and a professionally and/or educationally progressive environment at the institution or the district administration.

The computer implemented method and system disclosed herein enables modification of the performance goals and objectives to suit the requirements of each institution for evaluation of the performance of multiple entities of the institution. Moreover, the computer implemented method and system disclosed herein generates reports based on the tracked progress at different levels and provides the generated reports to the concerned entities via multiple communication modes. Furthermore, the computer implemented method and system disclosed herein provides systematic immediate feedback on the performance of multiple entities of the institution, thereby ensuring administrative accountability, and provides a tool for measuring growth of the performance goals. Furthermore, the computer implemented method and system disclosed herein quantifies results of the evaluation of the entities at the institution or the district administration based on multiple performance goals for facilitating accountability, professional development, and development of improvement programs.

The computer implemented method and system disclosed herein provides a progress management platform comprising at least one processor configured to track and manage the progress of performance goals. As used herein, the term “performance goal” refers to an end action result for an internal entity, for example, a superintendent at a district office, a principal, a teacher, a student, etc., that the internal entity needs to reach for improvement or conformance to a minimum requirement for development of the institution. The progress management platform is accessible by internal entities, external entities, etc., of the institutions, the district administrations, etc., via a network. As used herein, the term “internal entities” refers to persons, for example, a superintendent at a district office, a principal, a teacher, etc., at different levels in an institution or a district administration. Also, as used herein, the term “external entities” refers to non-members, for example, parents, visitors, etc., of the institutions. In an embodiment, the progress management platform is configured to be compatible with one or more of state government mandated education plans, education development programs, and classroom management tools.

The progress management platform receives goal information and goal criteria at one or more levels via a graphical user interface (GUI) provided by the progress management platform. The goal information comprises information on requirements for generating and achieving performance goals, for example, action items to be performed by internal entities at different levels in an institution to effect an improvement for development of the institution. The goal criteria comprise, for example, a set of rules determined by members of an institution or a district administration for reaching a performance goal. The internal entities and/or the external entities at different levels of the institutions and/or the district administrations input the goal information and the goal criteria to the progress management platform via the GUI. The progress management platform generates one or more modifiable performance goals at one or more of the levels using the received goal information and the goal criteria. In an embodiment, the progress management platform categorizes the generated modifiable performance goals at one or more of the levels into formal goals or informal goals. As used herein, the term “formal goals” refers to performance goals that are defined by an institution or a district administration for achieving standards as stipulated by standard evaluation bodies. Also, as used herein, the term “informal goals” refers to performance goals that are defined by an institution or a district administration for executing strategies, for example, instructional strategies, engagement strategies, professional development strategies, etc., developed by the institution or the district administration.

The progress management platform tracks progress of the generated modifiable performance goals, for example, by collecting and monitoring one or more of observations received on execution of the generated modifiable performance goals by the internal entities at one or more of the levels, self reviews and peer reviews received from the internal entities at one or more of the levels, feedback received from the external entities, etc., via the GUI. The progress management platform generates one or more progress reports at one or more of the levels based on the tracked progress of the generated modifiable performance goals to quantify results of the execution of the generated modifiable performance goals for facilitating accountability, professional development, and development of improvement programs. In an embodiment, the progress management platform generates one or more progress reports based on the categorization of the generated modifiable performance goals into formal goals or informal goals.

In an embodiment, the progress management platform generates one or more progress reports based on one or more of multiple source parameters associated with one or more of the received observations, the self reviews, the peer reviews, the received feedback, etc. The source parameters comprise, for example, a name of a source of each of the observations, the self reviews, the peer reviews, and the feedback, a staff to which the source belongs, a frequency of the reception of the observations, the self reviews, the peer reviews, and the feedback, etc.

In an embodiment, the progress management platform compares one or more of the observations, the peer reviews, and the feedback received for the internal entities with the self reviews performed by the internal entities and generates one or more comparison reports based on the comparison for facilitating the professional development of the internal entities. In an embodiment, the progress management platform generates one or more comparison reports at one or more of the levels based on one or more of multiple comparison parameters associated with the generated modifiable performance goals. As used herein, the term “comparison parameters” refers to factors that facilitate comparison and analysis of one or more performance goals. The comparison parameters are, for example, student strength of a classroom, average results of students in a classroom, etc. The comparison reports allow the internal entities at one or more of the levels of the institutions and the district administrations to analyze the tracked progress of the generated modifiable performance goals for each of the comparison parameters. In an embodiment, the progress management platform transmits one or more of the generated progress reports and one or more of the comparison reports to one or more of the internal entities at one or more of the levels using one or more communication modes, for example, electronic mail (email), a short message service (SMS), a multimedia messaging service, etc., over the network for allowing the entities to access and review the generated progress reports.

The progress management platform dynamically generates and maintains an advisory repository. The advisory repository stores the received goal information, the goal criteria, the generated modifiable performance goals, the received observations, the received self reviews, the received peer reviews, the received feedback, one or more progress reports generated based on a formal observation and/or an informal observation of the generated modifiable performance goals, one or more comparison reports, etc. As used herein, the term “formal observation” refers to an evaluation of the performance of internal entities at one or more levels of an institution based on formal goals that are defined by the institution for achieving standards as stipulated by standard evaluation bodies. Also, as used herein, the term “informal observation” refers to an evaluation of the performance of internal entities at one or more levels of an institution based on informal goals that are defined by the institution for executing strategies, for example, instructional strategies, engagement strategies, professional development strategies, etc., developed by the institution. The advisory repository of the progress management platform is accessible to the internal entities, the external entities, the institutions, the district administrations, etc., via the network for the development of the improvement programs. In an embodiment, the progress management platform provides a calendar interface for scheduling the development of improvement programs and/or a periodic assessment of the internal entities. The progress management platform dynamically generates alerts to notify the internal entities of, for example, schedules of the development of the improvement programs and the periodic assessment of the internal entities, events of the institutions and the district administrations, etc.

In an embodiment, the progress management platform creates a single entity account for each of the internal entities at one or more of the levels of the institutions and/or the district administrations. The single entity account allows each of the internal entities to track and manage the progress of the generated modifiable performance goals associated with each of the internal entities across one or more institutions and/or district administrations. In an embodiment, the progress management platform provides administrative access of internal entity accounts associated with the internal entities to one or more supervising entities at one or more of the levels of the institutions and the district administrations for accessing and tracking the progress of the generated modifiable performance goals of the internal entities at one or more of the levels of the institutions and/or the district administrations.

In an embodiment, the progress management platform categorizes the internal entities according to one or more of multiple categorization parameters comprising, for example, skills, qualification, competence, achievements, results of the execution of the generated modifiable performance goals, etc., of the internal entities for the development of the improvement programs at one or more of the levels of one or more institutions and/or the district administrations. In an embodiment, the progress management platform generates an accreditation score for each of the internal entities based on an achievement of the generated modifiable performance goals by the internal entities at one or more of the levels at one or more institutions and/or the district administrations. As used herein, the term “accreditation score” refers to a score assigned to an internal entity that decides the caliber of the internal entity in a field of work.

In an embodiment, the progress management platform establishes one or more professional learning communities for developing multiple pedagogical methods for professional development, skill acquisition, and skill enhancement of the internal entities at one or more of the levels at one or more of the institutions and the district administrations. In an embodiment, the progress management platform organizes and tracks progress of interactive student peer groups and/or interactive instructor-led coaching by the internal entities at the institutions. In an embodiment, the progress management platform provides a consultant log-in component to a visiting institution for collecting information associated with the generated modifiable performance goals and the generated progress reports for the development of the improvement programs at the visiting institution.

In an embodiment, the progress management platform performs one or more of multiple actions associated with information resources for the development of the improvement programs. As used herein, the term “information resources” refers to a collection of data from multiple resources that can be used by one or more internal entities at multiple levels of an institution or a district administration. The information resources are, for example, links to external education material, links to video and audio files uploaded by the internal entities, etc. The actions comprise, for example, promotion, sale, review, rating, and modification of the information resources. In an embodiment, the advisory repository of the progress management platform stores the information resources for facilitating access and use of the information resources by the internal entities, information of internal entity accounts associated with the categorized internal entities to generate a list of the categorized internal entities, the accreditation score for each of the internal entities, etc.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and components disclosed herein. The description of a structure or a method step referenced by a numeral in a drawing carries over to the description of that structure or method step shown by that same numeral in any subsequent drawing herein.

FIG. 1 illustrates a computer implemented method for tracking and managing progress of performance goals developed by one or more institutions and one or more district administrations at multiple levels.

FIGS. 2A-2B exemplarily illustrate a flowchart of options provided by a progress management platform to internal entities for tracking and managing progress of performance goals developed by one or more institutions and one or more district administrations at multiple levels.

FIG. 3 exemplarily illustrates a computer implemented system for tracking and managing progress of performance goals developed by one or more institutions and one or more district administrations at multiple levels.

FIG. 4 exemplarily illustrates the architecture of a computer system employed by the progress management platform for tracking and managing progress of performance goals developed by one or more institutions and one or more district administrations at multiple levels.

FIGS. 5A-5B exemplarily illustrate screenshots of a graphical user interface (GUI) provided by the progress management platform for generating performance goals based on goal information and goal criteria.

FIGS. 5C-5D exemplarily illustrate screenshots of a graphical user interface (GUI) provided by the progress management platform for tracking and managing progress of performance goals.

FIGS. 6A-6E exemplarily illustrate progress reports generated by the progress management platform.

FIGS. 6F-6G exemplarily illustrate a formal summary report generated by the progress management platform.

FIGS. 7A-7B exemplarily illustrate lists of walk through progress reports generated by the progress management platform.

FIGS. 8A-8B exemplarily illustrate screenshots of a graphical user interface provided by the progress management platform for performing a peer review.

FIGS. 9A-9B exemplarily illustrate screenshots of a graphical user interface provided by the progress management platform for performing a self review.

FIG. 9C exemplarily illustrates a screenshot of a graphical user interface provided by the progress management platform for performing a formal self review.

FIG. 10 exemplarily illustrates a progress report of a self review generated by the progress management platform.

FIG. 11 exemplarily illustrates a screenshot of a performance goal management interface provided by the progress management platform.

FIGS. 12A-12B exemplarily illustrate screenshots of a graphical user interface provided by the progress management platform for tracking and managing progress of performance goals by a senior member of an educational institution.

FIG. 13 exemplarily illustrates a screenshot of a graphical user interface provided by the progress management platform that allows an internal entity to selectively track and manage progress of performance goals across multiple institutions to which the internal entity belongs.

FIGS. 14A-14B exemplarily illustrate screenshots of a graphical user interface provided by the progress management platform for accessing information resources.

FIG. 15 exemplarily illustrates a screenshot of a graphical user interface provided by the progress management platform, displaying help options provided to internal entities.

### DETAILED DESCRIPTION OF THE INVENTION

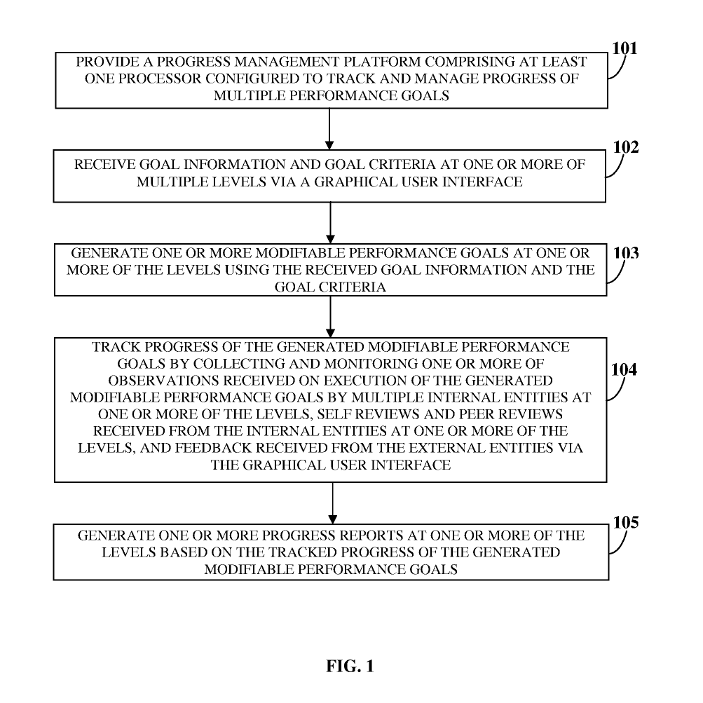

FIG. 1 illustrates a computer implemented method for tracking and managing progress of performance goals developed by one or more institutions and one or more district administrations at multiple levels. As used herein, the term “performance goal” refers to an end action result for an internal entity, for example, a superintendent at a district office, a principal, a teacher, a student, etc., that the internal entity needs to reach for improvement or conformance to a minimum requirement for development of the institution. Also, as used herein, the term “institution” refers to an establishment or an organization working towards a particular cause or a program. The institution is, for example, an educational institution, a medical institution, a financial institution, etc. Also, as used herein, the term “district administration” refers to a monitoring body of persons supervising multiple institutions in a particular geographical location, for example, an administrative division of a city, a county, etc. Also, as used herein, the term “level” refers to a hierarchical position in a system of persons belonging to an institution or a district, who are organized into graded ranks. For example, the levels in an educational system comprise a district administration level for a particular locality or a district, a school level headed by a principal within the district, a staff level comprising teachers, peer coaches, etc., a parental level, a student level, etc.

The computer implemented method disclosed herein provides 101 a progress management platform comprising at least one processor configured to track and manage progress of the performance goals. The progress management platform tracks goals developed, for example, by independent districts and schools. In an embodiment, the progress management platform is implemented as a website or as a web based platform hosted on a server or a network of servers. In another embodiment, the progress management platform is built on a hypertext markup language 5 (HTML5) web standard and utilizes industry standard server technologies, for example, Microsoft® SQL Server® of Microsoft Corporation and Adobe® Cold Fusion of Adobe Systems Incorporated®. While many of the coding techniques are standardized, and a few functions are received from public repositories, the progress management platform as a whole, including both structural elements and business logic, is designed and developed directly from requirements supplied by a programmer skilled in the programming art.

In another embodiment, the progress management platform is configured as a software application downloadable and executable on an entity device. The entity device is a computing device, for example, a personal computer, a tablet computing device, a mobile computer, a mobile phone, a smart phone, a portable computing device, a laptop, a personal digital assistant, a touch centric device, a workstation, a client device, a portable electronic device, a network enabled computing device, an interactive network enabled communication device, any other suitable computing equipment, and combinations of multiple pieces of computing equipment, etc. The entity device may also be a hybrid device that combines the functionality of multiple devices. Examples of a hybrid device comprise a cellular telephone that includes a media player functionality, a cellular telephone that includes electronic mail (email) functions, and a portable device that receives email, supports mobile telephone calls, and supports web browsing. Computing equipment may be used to implement applications such as a web browser, a mapping application, an email application, a calendar application, etc. Computing equipment, for example, one or more servers may be associated with one or more online services. In an embodiment, the progress management platform is downloadable as an iPad® application of Apple, Inc., on the entity devices via the network.

In another embodiment, the progress management platform is implemented in a cloud computing environment. As used herein, the term “cloud computing environment” refers to a processing environment comprising configurable computing physical and logical resources, for example, networks, servers, storage, applications, services, etc., and data distributed over a network, for example, the internet. The cloud computing environment provides on-demand network access to a shared pool of the configurable computing physical and logical resources. The progress management platform is a cloud computing based platform implemented as a service for tracking and managing the progress of performance goals developed by one or more institutions and/or district administrations at different levels. The progress management platform is developed, for example, using the Google App engine cloud infrastructure of Google Inc. In an embodiment, the progress management platform is configured to be compatible with one or more of state government mandated education plans, education development programs, and classroom management tools.

The progress management platform is accessible by internal entities and external entities of one or more institutions and/or one or more district administrations via a network. As used herein, the term “internal entities” refers to persons, for example, a district administrator, a superintendent at a district office, a principal, a teacher, etc., at different levels in an institution or a district administration. Also, as used herein, the term “external entities” refers to non-members, for example, parents, visitors, etc., of the institutions. The network for accessing the progress management platform is, for example, the internet, an intranet, a wired network, a wireless network, a network that implements Wi-Fi® of the Wireless Ethernet Compatibility Alliance, Inc., an ultra-wideband communication network (UWB), a wireless universal serial bus (USB) communication network, a communication network that implements ZigBee® of ZigBee Alliance Corporation, a general packet radio service (GPRS) network, a mobile telecommunication network such as a global system for mobile (GSM) communications network, a code division multiple access (CDMA) network, a third generation (3G) mobile communication network, a fourth generation (4G) mobile communication network, a long-term evolution (LTE) mobile communication network, etc., a local area network, a wide area network, an internet connection network, an infrared communication network, etc., or a network formed from any combination of these networks. The progress management platform is accessible to the institutions, the district administrations, the internal entities, and the external entities, for example, through a broad spectrum of technologies and devices such as personal computers with access to the internet, internet enabled cellular phones, tablet computing devices, etc. The internal entities and the external entities can access the progress management platform from any location as the progress management platform is configured as a web based application. In an embodiment, the internal entities and the external entities can capture observable data even when they are offline. In this embodiment, the internal entities and the external entities can upload the observed data once they log in to the progress management platform via the network.

The progress management platform receives 102 goal information and goal criteria at one or more of the levels via a graphical user interface (GUI) provided by the progress management platform. The GUI is, for example, a webpage of a website hosted by the progress management platform, an online web interface, a web based downloadable application interface, a mobile based downloadable application interface, etc. The goal information comprises information on requirements for generating and achieving performance goals, for example, action items to be performed by internal entities at different levels in an institution to effect an improvement for development of the institution. The goal information comprises, for example, existing performance issues related to a grade point average (GPA) of a student, supervision required in classrooms, student engagement required, etc. The goal criteria comprise, for example, a set of rules determined by the internal entities of an institution or a district administration for reaching a performance goal. The internal entities may submit the goal information, the goal criteria, and information on the institution and the district administration and other internal entities to the progress management platform via the GUI.

The progress management platform generates 103 one or more modifiable performance goals at one or more of the levels using the received goal information and the goal criteria. The progress management platform allows the internal entities of a district administration or an institution to modify or change the performance goals at their discretion based on their requirements or local needs via the GUI. The progress management platform allows districts to create their own custom performance goals based on local needs and allows districts to quantify the results for the purpose of professional development and program improvement. In an example, the performance goals may be set for a senior internal entity of an educational institution for an achievable grade point average (GPA) based on existing performance issues related to the GPA of a student. In another example, a performance goal for a superintendent at a district office is to walk through school sites and classrooms once a week. The walk through is a form of an audit that is implemented to determine learning and teaching practices in schools and other educational institutions. The walk through is also a process of giving and receiving non-threatening evidence based feedback. The walk through is a strategy for breaking down isolation and promoting collegiality, rather than typical formal observation rounds conducted by supervisors. In another example, a performance goal for a principal of a high school is to walk through every classroom three times a week. In another example, a performance goal for a teacher is to achieve 90% student engagement.

Consider an example where a senior staff member accesses the progress management platform and provides goal information such as existing performance issues related to reading abilities, writing abilities, listening abilities, etc., associated with a student's academic performance and provides the goal criteria for the generation of performance goals. The progress management platform automatically generates performance goals based on the goal information and the goal criteria received from the senior staff member of the institution. In an embodiment, the progress management platform generates recommendations, for example, tips, advice, action items, etc., that may be used or performed to achieve the generated performance goals.

The progress management platform tracks 104 progress of the generated modifiable performance goals by collecting and monitoring one or more of observations received on execution of the generated modifiable performance goals by the internal entities at one or more of the levels, self reviews and peer reviews received from the internal entities at one or more of the levels, feedback received from the external entities, etc., via the GUI. The observations are obtained by a senior internal entity of a district administration or a senior internal entity of an institution at a higher level by overseeing or supervising an internal entity of a district or an institution at a lower level. The senior internal entity inputs the observations to the progress management platform via the GUI. In an example, the progress management platform receives observations obtained by a principal of an educational institution by scoring, marking, grading, evaluating, etc., an internal entity such as a teacher of the educational institution, via the GUI, with respect to performance goals generated for the teacher. In another example, peer coaches, principals, district administrators may perform walk through observations regularly of their staff based on the performance goals created by the institutions and/or the district administrations and submit their observations to the progress management platform via the GUI. The progress management platform stores the walk through observation data in an advisory repository. The walk through observation data stored by the progress management platform is accessible by the entire staff of an institution or a district administration. Accessibility to walk through observation data offers the district, typical walk through data for individual teachers and district wide focus of system wide goals. Walk through observation data provides a focus on learning and teaching, allows school improvement that links effective practices with desired outcomes, triggers giving and receiving of non-threatening evidence based feedback, provides a strategy for breaking down isolation and promoting collegiality, keeps administrators in touch with day-to-day happenings in a classroom, allows improvement of rapport with students, etc. In an embodiment, the progress management platform enables a senior internal entity or one or more teams of senior internal entities of an institution or a district administration to perform walk through observations of one or more of the internal entities or one or more teams of the internal entities of an institution or a district at predefined intervals via the GUI of the progress management platform.

The progress management platform also tracks progress of the generated modifiable performance goals by collecting and monitoring self reviews and peer reviews received from the internal entities at one or more of the levels via the GUI. Self reviews are self assessments made by an internal entity with respect to the performance goals generated for the internal entity, by evaluating himself/herself for the purpose of personal growth. The internal entity submits their self reviews to the progress management platform via the GUI. Peer reviews are performed by peers of an internal entity, where the peers submit their evaluations of the internal entity to the progress management platform via the GUI. The progress management platform also tracks progress of the generated modifiable performance goals by collecting and monitoring feedback received from external entities via the GUI. The feedback comprises, for example, objective feedback, narrative feedback, important comments, inputs, suggestions provided by external entities such as parents, visitors, etc., of the institution, etc. The progress management platform receives feedback, for example, specific comments and inputs intended for improvement of programs of the institution, personal growth of an internal entity being observed, etc., from the external entities. Furthermore, the progress management platform allows external entities to provide suggestions, solutions for various reviews, for example, self reviews, peer reviews, observations, etc., via the GUI. In an example, districts, schools, and classrooms can provide the goal information and the goal criteria to the progress management platform via the GUI for generation of performance goals and receive feedback from parents. Parents can respond to the performance goals based on the performance goals set, for example, from a school system and leave specific comments intended for school improvement via the GUI. The progress management platform thereby enables all of the internal entities at different levels to give and receive feedback for all management entities, certificated entities, classified entities, secretarial entities, custodial entities, administrative entities, teachers, etc., of an institution.

The progress management platform generates 105 one or more progress reports at one or more of the levels based on the tracked progress of the generated modifiable performance goals to quantify results of the execution of the generated modifiable performance goals for facilitating accountability, professional development, and development of improvement programs. The progress report is, for example, a score sheet, an evaluation report, a report in the form of a graphical representation, etc., that shows an internal entity's performance in achieving a performance goal. The progress management platform generates the progress reports, for example, based on an evaluation of a teacher by a principal of an educational institution, an evaluation of a principal by a superintendent of a district administration, etc. The progress reports are accessible by the internal entities at different levels, for example, an individual staff level, a course level, a grade level, a department level, a school level, a district level, etc.

In an embodiment, the progress management platform categorizes the generated modifiable performance goals at one or more of the levels into formal goals or informal goals. As used herein, the term “formal goals” refers to performance goals that are defined by an institution or a district administration for achieving standards as stipulated by standard evaluation bodies. Also, as used herein, the term “informal goals” refers to performance goals that are defined by an institution or a district administration for executing strategies, for example, instructional strategies, engagement strategies, professional development strategies, etc., developed by the institution or the district administration. The progress management platform is configured to collect observational data, organize the observational data, and report the observational data to the internal entities and the external entities at one or more of the levels of the institutions and the district administrations in order to track and manage the progress of the performance goals more efficiently. The progress management platform organizes the process of generating the performance goals, for example, district goals, school goals, departmental goals, individual goals, etc., and categorizing the observational data associated with the generated performance goals into multiple categories, for example, formal observations, informal observations, etc., by the internal entities at different levels of the institutions and the district administrations.

The informal goals for an informal observation are generated for any plan or strategy, for example, instructional strategies, the common core state standards initiative, engagement strategies, professional development, specially designed academic instruction in English (SDAIE), English language development (ELD), western association of schools and colleges (WASC), etc. As used herein, the term “informal observation” refers to an evaluation of the performance of internal entities at one or more levels of an institution based on informal goals that are defined by the institution for executing strategies, for example, instructional strategies, engagement strategies, professional development strategies, etc., developed by the institution. Formal observations are performed on formal goals that focus on, for example, the California standards for the teaching profession (CSTP). As used herein, the term “formal observation” refers to an evaluation of the performance of the internal entities at one or more levels of an institution based on formal goals that are defined by the institution for achieving standards as stipulated by standard evaluation bodies. In an embodiment, the progress management platform collects informal observations for informal goals and formal observations for formal goals at the same time, providing one platform to track and aggregate the observational data collected for each of the processes of collecting the informal observations and the formal observations.

The collected observational data is used by the progress management platform to create professional development conversations and system improvements. In an embodiment, the progress management platform facilitates juxtaposed formal observation and informal observation data gathering and reporting. The progress management platform functions both as a walk through tool and a formal reporting tool. Each performance goal and accompanying goal criteria is associated to an internal entity account and can be either formal or informal, with an exception of user/staff level goals which can either be formal goals and/or informal goals.

From a single school to a large and growing district, the progress management platform can be customized according to the requirements of the institutions and the district administrations for organizing and managing the institutions and the district administrations without compelling the internal entities at one or more of the levels of the institutions and the district administrations to conform to a method of operation of the progress management platform, thereby boosting the procedure of performing an informal walk through, providing formal observations, and observation productivity of the institutions and the district administrations. The progress management platform enables the internal entities at different levels of the institutions and the district administrations to determine the performance goals and associate the performance goals to relevant observable data, for example, based on staff types such as certificated and/or general, departments, courses, grade levels, individuals, etc. As a result, the internal entities can create any combination of observable data associated with the performance goals to track on the progress management platform, providing a concise and comprehensive context to observe and capture the flow of any type of observational data. The progress management platform stores data related to, for example, the district goals, the school goals, and the staff goals in the advisory repository. The performance goals are created, tracked, and reviewed on several levels, to allow each internal entity to be a part of the culture followed by the institution or the district administration. Since the progress management platform is a web based platform, all of the information stored in the advisory repository can be accessed by any internal entity that has an internet connection. Since all of the data is accessible to the internal entities at a single platform, the internal entities do not need to switch between multiple software applications, thereby allowing the internal entities to work smarter and faster. Since relevant observable data is connected to each performance goal defined by the internal entities, the internal entities can view only the performance goals that are dynamically associated with the individual staff selection made during performance of each informal observation or formal observation on the GUI, thereby enhancing the method of completing a custom informal observation or a custom formal observation. The progress management platform harnesses and places the complex power of customization in the hand of every internal entity that subscribes with and logs in to the progress management platform.

In an embodiment, the progress management platform generates one or more progress reports based on the categorization of the generated modifiable performance goals into formal goals or informal goals. In this embodiment, the progress reports are configured to report any combination of the performance goals options from the formal observations and/or the informal observations of the generated modifiable performance goals. Disclosed below is an HTML5 implementation of a code snippet from a programming code named, for example, “/cfc/paQueries.cfc” implemented by the progress management platform for generating a progress report comprising both the formal goals and the informal goals:

```
<!---Get the Goal Set titles and sequences for both obsForm and Reporting--->
<cffunction name=“fGetGoalSets” returntype=“Query”>
<cfargument name=“argIsFormal” type=“numeric” required=“no” default=“0”>
<cfif argIsFormal NEQ 2>
<cfquery name=“getGoalSets” datasource=“#APPLICATION.dataSource#”
maxrows=“1”>
SELECT  <cfif argIsFormal>
                  goalSetTitleFormal_d AS title_1_d,
                  goalSetTitleFormal_s AS title_1_s,
            <cfelse>
                  goalSetTitle_d AS title_1_d,
                  goalSetTitle_s AS title_1_s,
            </cfif>
                  goalSetTitle_u, goalSetSequence_d, goalSetSequence_s,
goalSetSequence_u
```

| | |
|---|---|
| FROM | tblDistricts |
| WHERE | ID = <cfqueryparam cfsqltype=“cf_sql_bigint” |

value=“#SESSION.districtID#”>
</cfquery>
<cfelse>
<cfquery name=“getGoalSets” datasource=“#APPLICATION.dataSource#”
maxrows=“1”>

| | |
|---|---|
| SELECT | goalSetTitle_d AS title_1_d, goalSetTitleFormal_d AS title_2_d, |
| | goalSetTitle_s AS title_1_s, goalSetTitleFormal_s AS title_2_s, |
| | goalSetTitle_u, goalSetSequence_d, goalSetSequence_s, |

goalSetSequence_u

| | |
|---|---|
| FROM | tblDistricts |
| WHERE | ID = <cfqueryparam cfsqltype=“cf_sql_bigint” |

```
value=“#SESSION.districtID#”>
</cfquery>
</cfif>
<cfoutput>
<cfscript>
qryGoalSets = queryNew(“type, title”, “VarChar, VarChar”,
    [
        {type=“d1”,title=#getGoalSets.title_1_d#},
        {type=“s1”,title=#getGoalSets.title_1_s#},
        {type=“u”,title=#getGoalSets.goalSetTitle_u#}
    ]);
</cfscript>
</cfoutput>
<!--- When both Formal and Informal are selected for a summary report only, add the
informal goal sets after the formal goal sets in sequence (sort by type)--->
<cfif argIsFormal EQ 2>
<cfoutput>
<cfscript>
queryAddRow(qryGoalSets,
      [
        {type=“d2”,title=#getGoalSets.title_2_d#},
        {type=“s2”,title=#getGoalSets.title_2_s#}
    ]);
</cfscript>
</cfoutput>
</cfif>
<!--- Re-query and sort by Type --->
<cfquery name=“qryGoalSets” dbtype=“query”>
```

| | |
|---|---|
| SELECT | type, title |
| FROM | qryGoalSets |
| ORDER BY | type DESC |

</cfquery>
<cfreturn qryGoalSets/>
</cffunction>

In an embodiment, the progress management platform generates one or more progress reports based on one or more of multiple source parameters associated with one or more of the observations received on the execution of the generated modifiable performance goals by the internal entities at one or more of the levels, the self reviews and the peer reviews received from the internal entities at one or more of the levels, and the feedback received from the external entities. The source parameters comprise, for example, a name of a source of each of the observations, the self reviews, the peer reviews, and the feedback, a staff to which the source belongs, and a frequency of the reception of the observations, the self reviews, the peer reviews, and the feedback. In an example, district staff can access and print these progress reports to show who has performed the observations, of what staff, and how frequently.

The progress management platform dynamically generates and maintains the advisory repository. The advisory repository stores the received goal information, the goal criteria, the generated modifiable performance goals, the received observations, the received self reviews, the received peer reviews, the received feedback, the generated progress reports, the comparison reports, etc. In an embodiment, the advisory repository stores, for example, entity account information of the internal entities of the institutions and the district administrations, information associated with departments and courses of the institutions, etc. The advisory repository is, for example, a structured query language (SQL) data store or a not only SQL (NoSQL) data store such as the Microsoft® SQL Server®, the Oracle® servers, the MySQL® database of MySQL AB Company, the mongoDB® of 10gen, Inc., the Neo4j graph database, the Cassandra database of the Apache Software Foundation, the HBase™ database of the Apache Software Foundation, etc. In an embodiment, the advisory repository can also be a location on a file system. The advisory repository is any storage area or medium that can be used for storing data and files. In another embodiment, the advisory repository can be remotely accessed by the progress management platform via the network. In another embodiment, the advisory repository is configured as a cloud based database implemented in a cloud computing environment, where computing resources are delivered as a service over a network, for example, the internet. The advisory repository of the progress management platform is accessible to the internal entities, the external entities, the institutions, the district administrations, etc., via the network for development of improvement programs. The internal entities, the external entities, etc., access the advisory repository for the goal information, the goal criteria, the generated performance goals, the received observations, the received self reviews, the received peer reviews, and the received feedback that were stored at an earlier date for a future reference for development of the improvement programs.

The progress management platform allows the institutions and the district administrations to develop the goal information and the goal criteria and submit them to the progress management platform via the GUI. The progress management platform receives and displays the submitted goal information and the goal criteria on the GUI. The progress management platform enables the institutions and the district administrations to adopt different sets of performance goals based on the goal information and the goal criteria that may be vital for the purpose of professional development and personal growth of the internal entities of the institutions and the district administrations. The district administrations adopt and develop one or more sets of the goal information and the goal criteria that they want to track, monitor, and manage for all institutions in a particular geographical location, for example, all school sites in the districts managed by the district administrations, using the progress management platform. The institutions, for example, schools adopt and develop one or more sets of the goal information and the goal criteria that they want to track, monitor, and manage for institutional growth and school improvement efforts using the progress management platform. Individual employees develop the goal information and the goal criteria on which they want to receive feedback for professional development using the progress management platform. In an embodiment, the progress management platform allows an internal entity of an institution or a district administration to customize the goal information and the goal criteria via the GUI for the internal entity's personal development and growth, for which the progress management platform generates suitable performance goals. The progress management platform receives self reviews from an internal entity, and tracks and manages the progress towards achieving the performance goals generated for the internal entity. In an embodiment, the progress management platform periodically modifies the goal information and the goal criteria based on varying requirements of the institutions and the district administrations. The self reviews are accessible by the internal entity via the GUI for evaluation, observation, or comparison with previous observation data for personal growth of the internal entity.

In an embodiment, the progress management platform generates progress reports for various observations performed, for example, observations performed at the institutional level, observations performed at the district administration level, self reviews, peer reviews, etc. In an embodiment, the progress management platform allows the internal entities to access the progress reports for a particular date range. For example, an internal entity may choose to view the progress reports spanning a range of a day, a week, a month, etc., depending on the observations performed by the internal entity or the observations being performed on another internal entity.

The progress reports comprise the feedback associated with the observations of the internal entities of the institutions made by senior internal entities of the institutions and/or the district administrations. The feedback comprises, for example, constructive comments and inputs provided by a senior internal entity of the institution or the district administration for improvement and growth of the internal entities of the institutions being observed. In an embodiment, the observed internal entity and the senior internal entities of the district administrations and the institutions can print the generated progress reports for a future reference. In another embodiment, the progress management platform enables submission of classroom feedback, where senior internal entities, for example, teachers of the institutions develop specific performance goals for students. The students perform observations among their peers during interactive sessions such as classroom presentations, group work activities, etc., developed by the teachers of the institutions and enter peer feedback via the GUI of the progress management platform. The progress management platform generates progress reports comprising the observations and feedback provided by the students or peers of a classroom. In an embodiment, a teacher can obtain a print of the generated progress reports of all the feedback from the students of the classroom via the GUI of the progress management platform to analyze the overall patterns of the peer feedback. The progress management platform enables the teachers and other internal entities of the institutions to respond to the feedback from the students. The progress management platform thereby creates a continuous cycle of learning from the internal entities at different levels and among each peer group and provides instructions on how to provide constructive peer feedback for personal and classroom level improvement.

In an embodiment, an internal entity such as a district administrator, a principal, a teacher, a stakeholder, etc., of an institution or a district administration observes execution of performance goals and provides inputs and comments for the improvement of the institution or the district administration via the GUI of the progress management platform. The progress management platform ensures that every internal entity of the institution and the district administration is involved in the improvement process, especially every internal entity associated with the stated performance goals, and specifically targets areas of improvement. The progress management platform ensures district wide alignment of performance goals and priorities. In an educational system, the progress management platform ensures vertical alignment of performance goals from the district level down to the students and provides every stakeholder in the educational system with a voice to review and provide input into school improvement efforts. The progress management platform allows schools to track the improvement process and specifically target areas of improvement.

In another embodiment, the progress management platform provides a consultant log-in component via the GUI for teams of educational professionals who visit sites in multiple geographical locations to collect data and provide the data to a visiting school as a part of program improvement, school improvement teams, Western Association of Schools and Colleges (WASC) visitation teams, etc. The progress management platform enables the internal entities of the district administrations to collect information pertaining to performance goals from an institution of visit and pass on the information to another institution as a part of program improvement, creation of school improvement teams, WASC visitation teams, etc. In an embodiment, the consultant log-in component enables a visiting institution to collect information associated with, for example, the generated modifiable performance goals and the generated progress reports for the development of the improvement programs at the visiting institution. The progress management platform enables customization of performance goals, provides systematic immediate feedback for staff members, ensures administrative accountability and accountability for leadership, and provides a tool for measuring growth for performance goals that are typically difficult to quantify. The progress management platform efficiently uses time to track and manage the growth of the performance goals.

In an embodiment, the progress management platform creates a single entity account for each of the internal entities at one or more of the levels of one or more of the institutions and the district administrations. The single entity account allows each of the internal entities to track and manage the progress of the generated modifiable performance goals associated with each of the internal entities across the institutions and the district administrations. In this embodiment, the progress management platform provides a multi-site switching component accessible to the internal entities. The progress management platform allows the internal entities to have a customized view and isolated data access to data and functions of websites associated with institutions and/or district administrations located in multiple geographical locations in the single entity account. Consider an example where a teacher is employed by more than one school in a district, and as such, needs to have access to data associated with his/her professional activities from all the schools. The progress management platform allows the teacher to access the data seamlessly using a single login account. The teacher subscribes to and logs in to the progress management platform to create the single entity account. When the teacher selects a new location or site of one of the schools of which the teacher is an employee, the algorithm implemented by the progress management platform for the site-switching process resets the entity account's session variables that are associated with the selected location. The progress management platform then treats the entity account of the teacher as if the teacher has logged in to that site location initially. In an embodiment, the site-switching feature of the progress management platform is available for both school level entity accounts and staff level entity accounts.

In an embodiment, the progress management platform compares one or more of the observations, the peer reviews, and the feedback received for the internal entities with the self reviews performed by the internal entities and generates one or more comparison reports based on the comparison for facilitating the professional development of the internal entities. In an embodiment, the progress management platform generates one or more comparison reports at one or more of the levels based on one or more of multiple comparison parameters associated with the generated modifiable performance goals. As used herein, the term “comparison parameters” refers to factors that facilitate comparison and analysis of one or more performance goals. The comparison parameters are, for example, student strength of a classroom, average results of students in a classroom, etc. The comparison reports allow the internal entities at one or more of the levels of the institutions and the district administrations to analyze the tracked progress of the generated modifiable performance goals for each of the comparison parameters. For example, the progress management platform allows the internal entities to generate comparison reports that allow an analysis of any combination of up to 5 dynamically selected comparison parameters across up to 5 date ranges. The resultant comparison report displays a selection of observational data and performance goals that are common across all the selected comparison parameters. For example, an internal entity can query the progress management platform to generate a comparison report comprising comparison results of a walk through performed for an entire school, a single department, an entire grade level, and an individual staff member for a year to date period of fall of 2012 to fall of 2013. In an embodiment, the progress management platform enables one or more of the internal entities at one or more of the levels to analyze the generated progress reports and the comparison reports for development of improvement programs. Disclosed below is an HTML5 implementation of a code snippet from a programming code implemented by the progress management platform for generating the comparison report based on the comparison parameters specified by an internal entity:

In an embodiment, the progress management platform transmits the generated progress reports and the comparison reports to the internal entities at one or more of the levels using one or more communication modes, for example, an electronic mail (email), a short message service message (SMS), a multimedia messaging service (MMS) message, a telephonic message, etc., over the network. In an embodiment, the progress management platform transmits data from the observation of an observed internal entity contained in a generated progress report to the observed internal entity and an observing internal entity, for example, via an email. In an embodiment, the progress management platform transmits automated email feedback instantly to both the observed internal entity and the observing internal entity. The generated progress report is stored in the advisory repository. Consider an example where a superintendent of a district administration evaluates a principal of an educational institution with respect to the performance goals generated by the progress management platform for the principal. The superintendent enters his/her observations via the GUI of the progress management platform. On receiving the observations from the GUI, the progress management platform generates a progress report based the observations entered by the superintendent for the principal and transmits the generated progress report to the superintendent and/or the principal using one of the communication modes, for example, an email, an SMS message, etc. In an embodiment, the principal, the superintendent, any staff entity, any internal entity of a district administration can avail a printed copy of the generated progress report via the GUI of the progress management platform to reflect on observational data inputted by an observing internal entity. The progress reports can be printed, for example, based on individual teacher, course, grade level, department, school, or district. The progress reports can be reviewed by individual staff members or a team of staff members via the GUI. District staff members can print another progress report to show who has performed observations, of what staff, and how frequently, to allow for accountability for a management team. The progress management platform ensures administrative accountability, for example, by tracking progress of administration for expected observations at the school level. The internal entities, the external entities, etc., may also access the generated progress reports, the comparison reports, etc., from the advisory repository via the network.

In an embodiment, the progress management platform provides administrative access of internal entity accounts associated with the internal entities to one or more supervising entities at one or more of the levels of the institutions and/or the district administrations for accessing and tracking the progress of the generated modifiable performance goals of the internal entities at one or more of the levels of the institutions and the district administrations. The progress management platform facilitates administrative goal management by the internal entities having a supervisor level access. In this embodiment, the progress management platform allows not only the individual internal entities, but also any supervisor level entity account that has access to a staff list of the institution and the district administration stored in the advisory repository of the progress management platform to access goal management options of the individual internal entity accounts. In this embodiment, the progress management platform allows access of the internal entity accounts in the staff list to the supervisor level entity accounts by passing an identifier of each of the internal entity accounts registered with the progress management platform in a uniform resource locator (URL) string and employing a security check to verify and authenticate the supervisor level entity accounts. Disclosed below is an HTML5 implementation of a code snippet from a programming code named, for example, “adminGoals.cfm” implemented by the progress management platform for the authentication of the supervisor level entity accounts:

<cfset vEntity = #URL.entity#>
<cfset vEntitySingle = #left(vEntity, len(vEntity) −1)#>
<cfset vEntityType = #left(LCase(vEntity),1)#>
<cfset vTableName = “tbl” & #vEntity#>
<!---NEW Multi-Site Users--->
<cfif vEntityType EQ ‘u’>
<cfset vViewName = ‘vUsersSchools’>
<cfelse>
<cfset vViewName = “tbl” & #vEntity#>
</cfif>
<!---Security check for the correct entityID based on URL.entityUID--->
<cfquery name=“getID” datasource=“#APPLICATION.dataSource#”
maxrows=“1”>

| | |
|---|---|
| SELECT | <cfif vEntityType NEQ “u”>ID<cfelse>userKey</cfif> AS |

entityID, <cfif vEntityType NEQ “d”>districtID<cfelse>ID</cfif> AS
districtID

| | |
|---|---|
| FROM | #vViewName# |
| WHERE | <cfif vEntityType NEQ “u”>UID<cfelse>userID</cfif> LIKE |

<cfqueryparam cfsqltype=“cf_sql_varchar” value=“#URL.entityUID#”>
</cfquery>
<cfset vEntityID = #getID.entityID#>
<cfset vDistrictID = #getID.districtID#>
<cfset vEntityUID = #URLentityUID#>

In an embodiment, the progress management platform generates an accreditation score for each of the internal entities based on achievement of one or more of the generated modifiable performance goals by the internal entities at one or more of the levels at one or more of the institutions and/or the district administrations. As used herein, the term “accreditation score” refers to a score assigned to an internal entity that decides the caliber of the internal entity in a field of work. In an embodiment, the accreditation score is determined based on multiple factors, for example, level of achievement of a performance goal by an internal entity, a degree of result obtained by an internal entity in a field of work, etc. The accreditation score can be classified in ascending or descending order of categorization. For example, a principal of a school decides to rate all teachers of the school based on an average percentage of passed students in their respective classes. The principal assigns the teachers the accreditation score from a range of 1 to 5 via the GUI of the progress management platform based on the average percentage of passed students in their respective classes.

In an embodiment, the progress management platform categorizes the internal entities according to one or more of multiple categorization parameters for the development of improvement programs at one or more of the levels of the institutions and the district administrations. The categorization parameters comprise, for example, skills, qualification, competence, achievements, results of the execution of the generated modifiable performance goals, etc., of the internal entities. In another embodiment, the progress management platform categorizes the internal entities based on the accreditation score assigned to each of the internal entities based on achievement of the performance goals by the internal entities. In an embodiment, the advisory repository dynamically stores and maintains a list of the categorized internal entities in a talent database for facilitating enhanced access to superior internal entities at one or more of the levels of the institutions or the district administrations. In an embodiment, the talent database facilitates recognition of talented internal entities by the institutions and the district administrations for implementation of improvement programs.

In an embodiment, the progress management platform establishes one or more professional learning communities (PLC) for developing multiple pedagogical methods for professional development, skill acquisition, and skill enhancement of the internal entities at one or more of the levels at one or more of the institutions and the district administrations. In an embodiment, the progress management platform triggers professional conversations among the internal entities, for example, at staff meetings, PLC meetings, or department meetings, etc., via the GUI. The PLCs aim at facilitating collaborative learning among the internal entities of the institutions and the district administrations. In an embodiment, the internal entities can voluntarily group themselves into PLC groups via the progress management platform. In another embodiment, superior internal entities can group the internal entities into PLC groups based on their performance via the progress management platform.

In an embodiment, the progress management platform performs one or more of multiple actions associated with information resources for development of the improvement programs. As used herein, the term “information resources” refers to a collection of data from multiple resources that can be used by one or more internal entities at multiple levels of an institution or a district administration. The information resources are, for example, links to external education material, links to video and audio files uploaded by the internal entities, etc. The actions comprise, for example, promotion, sale, review, rating, and modification of the information resources. The progress management platform allows the internal entities to promote, sell, purchase, review, rate, modify, etc., the information resources stored in a resource library maintained by the progress management platform. The progress management platform allows the internal entities to link immediate feedback provided by other internal entities with the information resources, and stores the links to the information resources in the advisory repository. In an embodiment, the progress management platform allows the internal entities to store the links to the information resources in the advisory repository in a custom format. In an embodiment, the advisory repository of the progress management platform stores the information resources for facilitating access and use of the information resources by the internal entities, information of internal entity accounts associated with the categorized internal entities to generate a list of the categorized internal entities, the accreditation score for each of the internal entities, etc.

The progress management platform allows the internal entities to send customized information resource links with every informal observation progress report or formal observation progress report that is completed by the internal entities. For example, if an internal entity wishes to reinforce a particular teaching standard from the California standards for the teaching profession (CSTP), the internal entity can create a link to the information resource that highlights a continuum of teaching practices associated with the teaching standard from the CSTP via the GUI of the progress management platform, and store the link in the resource library. In another example, if an internal entity wishes to target a specific student engagement strategy, the internal entity can create a link to a video hosted, for example, on YouTube® of Google, Inc., that best demonstrates the student engagement strategy in action via the GUI and store the link to the information resource in the resource library. Hence, the progress management platform facilitates maximizing individual coaching opportunities with every internal entity at each level of the institution or the district administration.

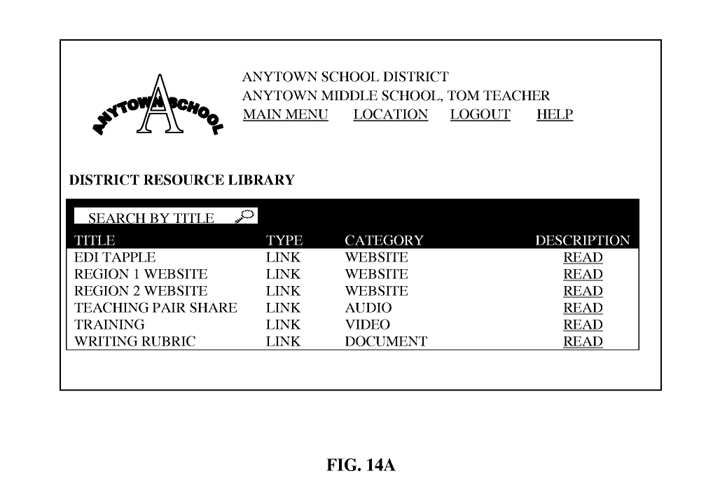

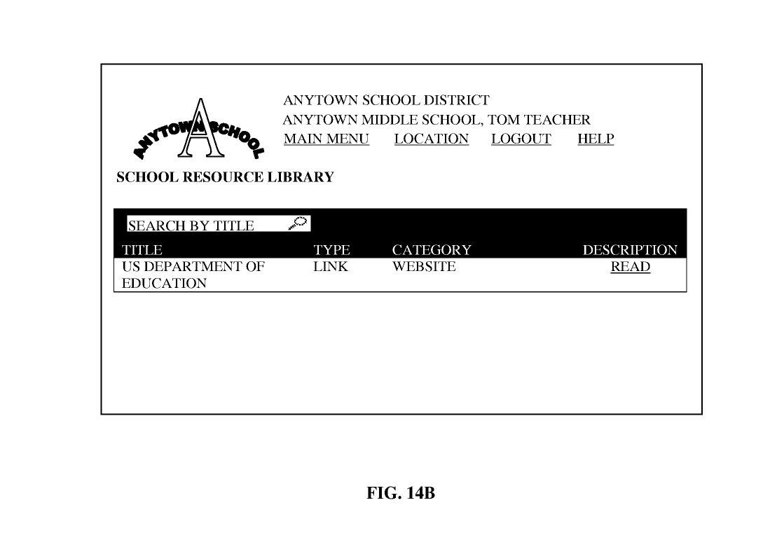

In an embodiment, the progress management platform allows the internal entities to select and access any information resource of any format, for example, a portable document format (PDF) file, a text document, an excel spreadsheet, an audio file, a video file, web links, etc., from the advisory repository. The progress management platform allows the internal entities to link the information resources to any performance goal or a set of performance goals that they wish to supplement or support. In an embodiment, the progress management platform categorizes the information resources in two types, for example, a district resource library and a school resource library, as exemplarily illustrated in FIGS. 14A-14B. Each internal entity can access the resource libraries via the GUI of the progress management platform after logging to an internal entity account. The progress management platform allows the internal entities to store, organize, and manage the information resources in their own district resource library and school resource library. The progress management platform allows each internal entity to access and review the information resource links instantly, for example, via a web browser on the entity device, and download, print or save the information resources at the internal entity's discretion. The progress management platform allows the internal entities to share the information resources with any other internal entity or an external entity by sending one or more links to the information resources embedded in the informal observation progress report or the formal observation progress report.

In an embodiment, the progress management platform organizes and tracks progress of one or more of interactive student peer groups and interactive instructor-led coaching by the internal entities at the institutions. In this embodiment, the progress management platform allows the internal entities, for example, teachers, principals, etc., to organize the interactive student peer groups or the interactive instructor-led coaching for students who require additional assistance with their studies. In this embodiment, the internal entities track the progress of the interactive student peer groups and the interactive instructor-led coaching via the progress management platform.

In an embodiment, the progress management platform provides a calendar interface for scheduling development of the improvement programs and/or a periodic assessment of the internal entities. Consider an example where a principal, Paul of a school wishes to maintain an alarm system on his tablet computing device that can remind him of the events and programs conducted in his school, rather than maintaining a diary, which requires manual labor and is prone to human error. Paul logs in to the progress management platform and selects an option of a calendar from the calendar interface of the progress management platform. The progress management platform provides Paul with a display to select a date and set up an alarm reminder for an event. In an embodiment, the progress management platform dynamically generates alerts to notify the internal entities of schedules of the development of the improvement programs and/or the periodic assessment of the internal entities, events of the institutions and the district administrations, etc. For example, if Paul selects a date and time on the calendar interface of the progress management platform to schedule an informal observation of class 5 of his school, the progress management platform dynamically generates alert and transmits the alert to Paul's tablet computing device on the specified date and time. The progress management platform may also provide the alert via the GUI of the progress management platform.

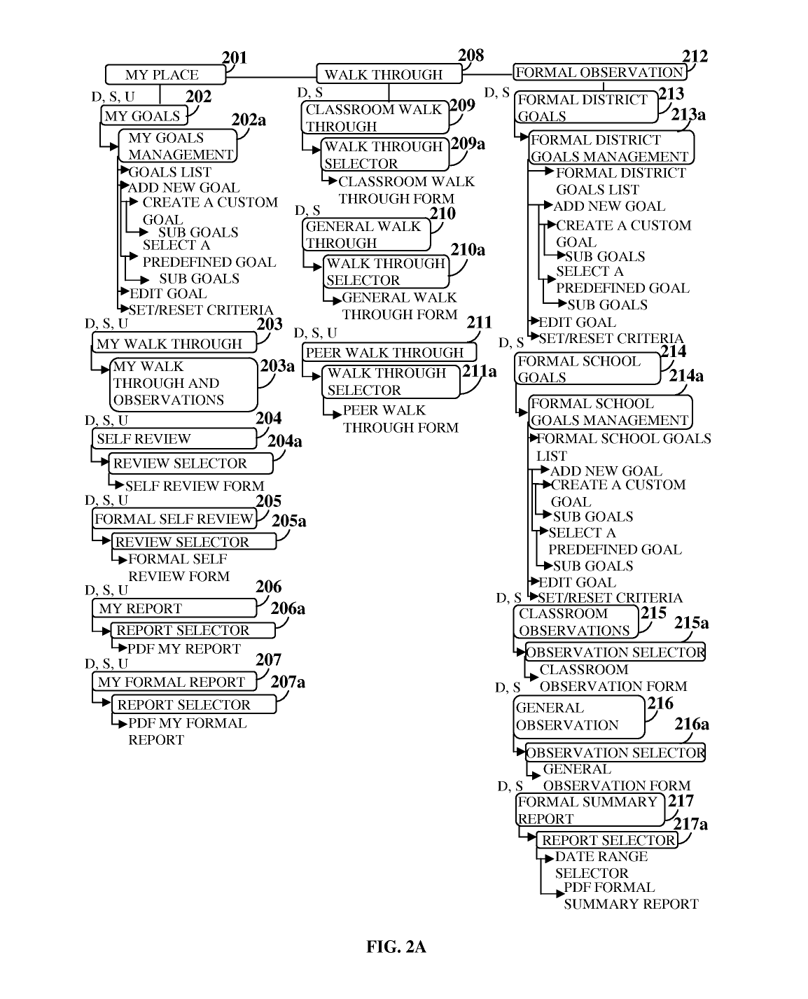

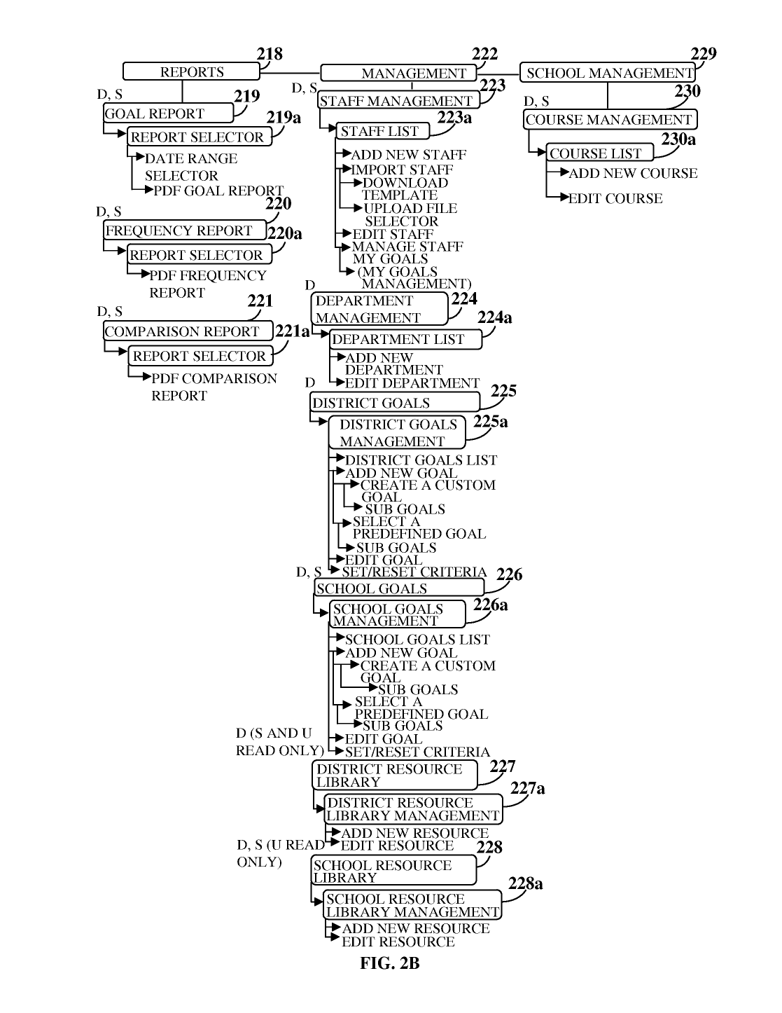

FIGS. 2A-2B exemplarily illustrate a flowchart of options provided by the progress management platform to internal entities for tracking and managing progress of performance goals, also referred to as “goals”, developed by one or more institutions and one or more district administrations at multiple levels. The progress management platform displays a main menu on the graphical user interface (GUI) to an internal entity after the internal entity subscribes to and logs in to the progress management platform. The main menu comprises multiple options, for example, a “my place” option 201, a “walk through” option 208, a “formal observation” option 212, a “reports” option 218, a “management” option 222, a “school management” option 229, etc. Each option provides multiple links to access multiple sub-options of the options provided on the GUI of the progress management platform based on a level of access provided to each of the internal entities. Each of the sub-options has further sub-options. The progress management platform provides, for example, district level features denoted by “D”, school level features denoted by “S”, and user level features denoted by “U”, to the internal entities based on the level of access provided to each of the internal entities. The “my place” option 201 comprises sub-options, for example, a “my goals” option 202, a “my walk through” option 203, a “self review” option 204, a “formal self review” option 205, a “my report” option 206, a “my formal report” option 207, etc.; the “walk through” option 208 comprises sub-options, for example, a “classroom walk through” option 209, a “general walk through” option 210, a “peer walk through” option 211, etc.; and the “formal observation” option 212 comprises sub-options, for example, a “formal district goals” option 213, a “formal school goals” option 214, a “classroom observations” option 215, a “general observation” option 216, a “formal summary report” option 217, etc., as exemplarily illustrated in FIG. 2A.

The “self review” option 204 further provides a “review selector” option 204a. Furthermore, the formal self review option 205 provides another “review selector” option 205a. The progress management platform 303 provides the “review selector” option, for example, 204a, 205a, etc., to allow the internal entities to select forms, for example, a self review form, a formal self review form, etc., to provide their self reviews. Each of the “my report” option 206 and the “my formal report” option 207 provides a “report selector” option, for example, 206a, 207a, etc., to allow the internal entities and/or the external entities to generate a portable document format (PDF) file of a selected report from the “my report” option 206 or the “my formal report” option 207. Furthermore, the “formal summary report” option 217 provides another “report selector” option 217a. The “report selector” option 217a allows the internal entities and/or the external entities to select, for example, a date range, a PDF file of the formal summary report, etc. Each of the sub-options, for example, the “classroom walk through” option 209, the “general walk through” option 210, the “peer walk through” option 211, etc., provides a “walk through” selector, for example, 209a, 210a, 211a, etc., to allow the internal entities and/or the external entities to select walk through forms. Moreover, each of the sub-options, for example, the “classroom observations” option 215, the “general observation” option 216, etc., provides an “observation selector” option, for example, 215a, 216a, etc., to allow the internal entities and/or the external entities to select observation forms to provide their observations.

If the internal entity wishes to input goals for the internal entity itself, the internal entity selects the “my goals” option 202 from the main menu. The “my goals” option 202, exemplarily illustrated in FIG. 2A, is a menu item provided to each internal entity including all staff level entity accounts, all school level entity accounts, and all district level entity accounts. The “my goals” option 202 allows each internal entity to enter as many individual goals as they choose. The individual goals are displayed to any internal entity performing a walk through for another internal entity. In an embodiment, the data associated with the individual goals is not included in the district, school, department, grade, or course reports. The individual goal data is only viewed by the individual internal entity and on an individual progress report. The progress management platform 303 provides a “my goals management” option 202a that provides further sub-options, for example, a goals list, an option to add new goals, edit goals, set or reset goal criteria, etc. In order to generate individual goals, the internal entity selects the “My Place” option 201 and then the “My Goals” option 202. The internal entity then selects an “Add New Goal” option and inputs a priority number in order to arrange the goals in a specific order based on the priority number assigned to the goals. The internal entity then provides goal information by inputting the goal name and the department and the grade level to which the goal applies, for example, certificated entities, instructional aides, etc.

In an embodiment, the internal entity can select all the classification types if the goal is relevant to all the classes. The internal entity then selects an “add” option to add the goals to the internal entity account. If the internal entity wishes to perform a self-review, the internal entity selects the “My Place” option 201 from the main menu and selects the “Self-Review” option. The internal entity then selects a grade and a course available for the location. The progress management platform then displays “my goals” for the internal entity selected, “school goals” for a grade level or a course type selected, and “district goals” for a grade level or a department type selected. The internal entity can then perform a self review on one or more course types or one or more grade levels. The progress report for the self review performed by the internal entity is available in the “my place” option 201 under the “my walk through” option 203. The “my walk through” option 203 further comprises a “my walk through and observations” sub-option 203a. The data available in the progress report for the self review can be used only by the internal entity associated with the progress report. The data associated with the self review is not included in progress reports associated with, for example, grade levels, course types, schools, institutions, district administrations, etc.

The progress management platform provides the “My goals” option 202 as a menu item in the “My place” option 201 for the internal entities including all staff level entity accounts, all school level entity accounts, and all district level entity accounts. The “My goals” option 202 allows each internal entity to enter as many individual formal goals as they choose. The individual formal goals are, for example, formal walk through goals, formal observation goals, or both. The formal goals are displayed for any internal entity that performs a walk through or a formal observation and has selected the name of the internal entity to which the selected formal goals apply. However, the data associated with the formal goals is not included in the district progress reports, school progress reports, department progress reports, grade progress reports, or course progress reports. The individual formal goals data can only be viewed by the individual internal entity and on an individual progress report associated with the individual internal entity.

In order to add formal goals, the internal entity selects the “my place” option 201 and then the “my goals” option 202. The internal entity then selects an “add new goal” option from the menu. The progress management platform prompts the internal entity to identify the type of the formal goal from a list comprising, for example, a walk through, a formal observation, or both. The internal entity inputs a priority number and a goal name for each of the formal goals and selects the “add” option to add the selected formal goals to the formal progress report of the internal entity. The progress management platform allows the internal entities to create a custom goal, create a sub goal, select a predefined goal or sub goal, edit goals, etc.

When an internal entity wishes to conduct a formal observation, the internal entity selects the “Formal observation” option 212 from the main menu. The progress management platform prompts the user to select a type of observation by selecting, for example, the “Classroom observations” option 215 for certificated entities or instructional aides, the “General observation” option 216 for all other internal entities of the institution or the district administration. In an embodiment, if the internal entity has a district level entity account, the progress management platform provides the internal entity with an additional option of selecting a location for performing the formal observation. The internal entity selects the staff type, for example, a certificated entity or an instructional aide, and the name of the staff. The internal entity then selects a “next” option to receive a formal observation form from the progress management platform based on the selections made by the internal entity. The types of formal observation forms are, for example, “my formal goals”, “formal school goals”, and “formal district goals”. The “my formal goals” option populates the formal observation form for an individual internal entity selected. The “formal school goals” option 214 populates the formal observation form for a grade level, a course type, and a staff type selected. The “formal district goals” option 213 populates the formal observation form for a grade level, a department type, and a staff type selected.

In order to perform a formal observation, the internal entity selects one of multiple objective feedback options based on the goal criteria established by the internal entity while generating the formal goals. In an embodiment, the progress management platform provides a default objective feedback option as “not applicable” to the internal entities while the internal entities perform the formal observation. A selection of the “not applicable” option by the internal entity implies that there is no data for the selected formal goal. For example, the internal entity selects the “not applicable” option for a “Learning objective posted” goal while performing a formal observation of a physical education class conducted in a playground, as the specified goal is not applicable at that moment in time. The internal entity inputs text comments for a specific objective feedback option by selecting a “comment” option or inputs text comments for the whole progress report by selecting an “Overall comment” option. The internal entity then selects the “submit” option and is prompted by the progress management platform for a confirmation by displaying a pop-up message as “Are you sure?”. On receiving confirmation from the internal entity, the progress management platform dynamically transmits an electronic mail (email) notification to the evaluating internal entity and evaluated internal entity, based on the settings selected by individual internal entities under the “staff management” option 223. The internal entities can access the formal observation progress report in the “my place” option 201 under the “my walk through” option 203. The data is available on the “formal summary report” option 217.

If the internal entity wishes to edit a walk through, the internal entity needs to select the “My Place” option 201 from the main menu and then select the “my walk through” option 203, exemplarily illustrated in FIG. 2A. The internal entity then locates the walk through progress report to be edited and selects the “edit” option. The progress management platform displays the selected walk through progress report on the GUI. The internal entity can then change the objective feedback by updating either the “comment” option or the “overall comment” option, and then selecting the “update walk through” option (not shown). The progress management platform then prompts the internal entity with a confirmation message before updating the walk through.

If the internal entity wishes to delete a walk through, the internal entity selects a “Delete this Walk Through” option (not shown). The progress management platform deletes the selected walk through after receiving a confirmation from the internal entity. The progress management platform transmits an email notification to the internal entity based on the settings saved by the internal entity in the internal entity account under the “staff management” option 223. The internal entity can then view the edited walk through progress report in the “My Place” option 201 under the “my walk through” option 203. The data in the walk through progress report is used on a goal report by the internal entity.

If the internal entity wishes to perform a classroom walk through, the internal entity needs to select the “walk through” option 208, exemplarily illustrated in FIG. 2A, from the main menu. The internal entity then selects the “classroom walk through” option 209. If the internal entity is logging in to the progress management platform using a district login identifier, then the internal entity can select the location of a school from a dropdown menu. The internal entity then selects the grade option that indicates the grades present in the selected school of the selected location. The internal entity then selects a course from a list of courses available in the school for the selected grade and then the staff type. The staff type for the grade is, for example, a certificated staff or an instructional aide. The instructional aide is, for example, a classified aide working in a classroom. The internal entity then selects the staff member from the selected staff type and selects the “next” option. The progress management platform displays “my goals”, if an individual staff member is selected, “school goals” if a grade level, a course, or a staff type is selected, or “district goals” if a grade level, a department, or a staff type is selected.

The internal entity then analyzes the performance of a staff member or a student based on the predefined goals or the customized goals. The progress management platform prompts the internal entity to select one of multiple objective feedback options provided to the internal entity via the GUI of the progress management platform based on the goals established by the internal entity. Furthermore, the progress management platform provides a “not applicable” option. The “not applicable” option selected for a goal by an internal entity implies that there is no data corresponding to the goal stored in the advisory repository. For example, for a walk through of a physical education class performed by a principal of a school if the goal for the course is “Learning Objective Posted”, the principal selects the “not applicable” option because the goal at the moment of time does not apply. The progress management platform prompts the internal entity with a comment option to allow the internal entity to input text comments into a text field of the comment option. In an embodiment, the progress management platform prompts the internal entity with an “overall comment” option to allow the internal entity to input text comments into text field of the “overall comment” option to write comments for the entire progress report. The internal entity then selects a “submit” option and the progress management platform prompts the internal entity with a notification, for example, a pop-up message displaying an “Are you sure?” message. Once the internal entity selects a “yes” option, the progress management platform instantly transmits an email notification to the internal entity observed and the observing internal entity as per the type of email notification selected by the internal entity in the “staff management” option 223. The internal entity can view the walk through progress report in the “My Place” option 201 under the “my walk through” option 203. The walk through progress report is in the form of, for example, a goal report and a comparison report.

The internal entity can perform a general walk through by selecting the “walk through” option 208 from the main menu and then by selecting the “general walk through” option 210. The internal entity can select the location from the “location” option, if the internal entity has a district level entity account. The internal entity then selects the “staff type”. The staff type is, for example, administration, confidential management, secretarial, custodial, maintenance, transportation, others, etc. The administration staff type comprises, for example, management entities. The confidential management staff type comprises, for example, non-union classified management entities in a district office. The secretarial staff type comprises, for example, office staff. The custodial staff type comprises, for example, cleaning staff. The maintenance staff type comprises, for example, maintenance staff. The transportation staff type comprises, for example, bus drivers, other transportation staff, etc. The others staff type comprises, for example, any other internal entity not classified in the above mentioned staff types. After the internal entity selects the desired staff type, the progress management platform provides a list of the internal entities and the location of the internal entities in the list. The internal entity then selects “Next” option, and the progress management platform provides “my goals”, if an individual internal entity is selected, and school goals/district goals if a staff type is selected.

The internal entity can perform a peer walk through by selecting the “walk through” option 208 from the main menu and then by selecting the “peer walk through” option 211. The internal entity can select a grade type from the “grade” option. In an embodiment, grade levels of only a selected location appear on the GUI of the progress management platform. The internal entity then selects the course type from a “course” option. The internal entity then selects the “staff type”. The internal entity then selects “Next” option, and the progress management platform provides “my goals” if an individual internal entity is selected, “school goals” if a grade level, a course type, or a staff type is selected, and “district goals” if a grade level, a department type, or a staff type is selected.

In an embodiment, the progress management platform allows the internal entity to perform a formal observation. The progress management platform provides a “Formal district goals” option 213 as a menu item for the district level entity accounts. The “formal district goals” option 213 allows the internal entities to enter as many district level goals as they choose. The “formal district goals” option 213 further comprises a “formal district goals management” option 213a that provides further sub-options, for example, formal district goals list, add new goals, edit goals, set or reset goal criteria, etc. In an embodiment, the progress management platform establishes formal district goals for every evaluation performed at every level of the institutions or the district administrations and/or can be specific to different staff types. The progress management platform displays formal district goals on the GUI for any internal entity who is performing an evaluation at any level of the institutions or the district administrations and who has selected the staff types that are linked to the selected formal district goals.

The internal entity selects a “formal observation” option 212, exemplarily illustrated in FIG. 2A, from the main menu. The internal entity then selects the “formal district goals” option 213. The progress management platform prompts the internal entity with two options, for example, “Add a new custom goal” or “Add a new predefined goal” to add the formal district goals. If the internal entity wishes to create a custom formal district goal, the internal entity selects the “Add a new custom goal” option from the menu and inputs a priority number for the formal district goal. The progress management platform uses the priority number to sort the formal district goals in descending/ascending order. The progress management platform pre-populates the priority number with a next available priority number. The internal entity inputs a goal name into the text box.

In an embodiment, the progress management platform provides the internal entity with an option, for example, “Include this goal on the whole district report”. If the internal entity checks the option, the performance goal data is displayed on the entire district progress report. If the internal entity unchecks the option, the performance goal data is not displayed on the entire district progress report. The internal entity then selects a staff type in the district to whom the formal district goals are made visible. In an embodiment, the internal entity can choose to select a “Select all” option to make the formal district goals visible to all the internal entities of the district. The internal entity then selects a goal status for the formal district goal. In an embodiment, the formal district goal is in active state by default. In another embodiment, the internal entity can change the goal status to inactive state if the internal entity wishes to maintain and store the observation data associated with the formal district goal in the advisory repository of the progress management platform. In this embodiment, the formal district goal does not appear on the current formal district observations progress report as the goal status is inactive. Finally, the internal entity selects an “add” option to add the custom formal district goal to the district progress report.

If the internal entity wishes to use predefined formal district goals in the district progress report, the internal entity selects the one or more of the formal district goals to add to a district goals list. The internal entity inputs a priority number for each of the selected formal district goals to arrange the formal district goals in descending or ascending order. The internal entity then inputs the goal name into the text box and checks or unchecks the “Include this goal on the whole district report” option. Furthermore, the internal entity selects the staff type and the goal status for the selected formal district goals and adds the selected formal district goals to the district progress report by selecting the “add” option. The internal entity then repeats the above mentioned steps to add additional custom formal district goals or predefined formal district goals.

The progress management platform provides the “Formal school goals” option 214, exemplarily illustrated in FIG. 2A, as a menu item for school level entity accounts and district level entity accounts. The “formal school goals” option 214 allows the internal entities to enter as many school level formal goals as they choose. The “formal school goals” option 214 further comprises a “formal school goals management” option 214a that provides further sub-options, for example, formal school goals list, add new goals, edit goals, etc. The formal school goals may be established for all the internal entities at different levels of the institutions or the district administrations or can be customized for different staff types. The formal school goals are displayed for any internal entity that performs a formal observation at the site and has selected one or more variables that are linked to the formal school goals.

The internal entity selects a “Formal observation” option 212 from the main menu and then selects the “Formal school goals” option 214 to select or create formal school goals. In an embodiment, the internal entity can add a custom formal school goal by selecting the “create new custom goal” or a predefined formal school goal by selecting the “add new predefined goals”. The internal entity then enters a priority number for the selected formal school goals and changes other settings of the selected formal school goals, for example, visibility of the selected formal school goals on the whole school progress report via an “Include this goal on the whole school report” option provided by the progress management platform, the staff type, the goal status, etc. The internal entity can then select the staff type and goal status for the selected formal school goals. The internal entity then adds one or more of the custom formal school goals and the predefined formal school goals by selecting the “add” option.

If the internal entity wishes to add school walk through goals, the progress management platform provides a “school goals management” option 226a, exemplarily illustrated in FIG. 2B, as a menu item for school level entity accounts and district level entity accounts. The school walk through goals is an example of informal goals at the school level. The school walk through goals option allows the internal entities to enter as many informal school goals as they choose. The school walk through goals may be established for every informal observation, for example, a walk through, at one or more levels of the institutions or the district administrations or can be customized for individual grade levels, individual staff types, or individual courses. The informal school goals are displayed to any internal entity performing an informal observation at different levels of the institutions or the district administrations and to whoever has selected the variables that are associated with the selected informal school goals.

The internal entity selects a “school goals” option 226 and then selects “add new custom goal” or “add new predefined goal” to add a customized informal school goal or a predefined informal school goal. The internal entity can then input a priority number and select a staff type and goal status for the selected informal school goal. The internal entity then selects the “add” option to add the selected customized informal school goal or the selected predefined informal school goal.

The progress management platform provides a formal summary report option 217 exemplarily illustrated in FIG. 2A, also referred to as “formal progress report”, of the walk through conducted by the internal entities at different levels of the institutions or the district administrations. The “formal summary report” option 217 is a menu item for district level entity accounts and school level entity accounts. The internal entities can view and print the formal summary report displaying the observation data and comments for an evaluated internal entity by a walk through conducted by another internal entity. The formal summary report is a report builder that shows all data over a selected date range. The internal entity can access a formal summary report by selecting “formal observation” option 212 from the main menu and then selecting the formal summary report option 217. In an embodiment, the internal entities that have district level entity accounts can select the location. The internal entity then selects a type of observation from the “observation” menu. The types of observation are, for example, “all observations”, “observations by me”, etc. The “all observations” category comprises all observation data stored in the advisory repository of the progress management platform for the performance goals and dates selected. The “observations by me” category comprises observation data corresponding to the walk through completed by the internal entity.

The internal entity then selects a type of staff to which the observed internal entity belongs by selecting a “staff type” option from the menu. The staff types are, for example, “certificated”, “instructional aide”, “classified”, “secretarial”, “administration”, “custodial”, etc. The “certificated” category comprises, for example, observation data of classroom teachers. The “instructional aide” category comprises, for example, observation data of classroom aides. The “classified” category comprises, for example, observation data of support personnel. The “secretarial” category comprises, for example, observation data of office staff. The “administration” category comprises, for example, observation data of principals, assistant principals, etc. The “custodial” category comprises, for example, observation data of custodians and maintenance staff. After selecting the staff type, the internal entity selects a “next” option and then the “staff” option to select an individual staff name from the menu provided by selecting the “staff” option. The internal entity then selects a date range by selecting a date from a “start date” option and an “end date” option. The internal entity then selects the “reports” option 218 that provides a list of types of progress reports generated by the progress management platform. The “reports” option 218 comprises, for example, “charts and comments”, “charts only”, “comments only”, etc. The “charts and comments” option provides the progress reports that show the entire walk through data of the selected evaluated internal entity along with all comments provided by the evaluating internal entities. The “charts only” option provides progress reports that show only charts associated with walk through data of the selected evaluated internal entity. The “comments only” option provides progress reports that show only comments associated with walk through data of the selected evaluated internal entity. After selecting the desired progress report option, the internal entity selects a “get report” option and the progress management platform generates the formal progress report. The progress management platform transmits the generated progress report to the internal entity via multiple communication modes, for example, electronic mail (email), a short message service (SMS) message, a multimedia messaging service (MMS) message, etc.

As exemplarily illustrated in FIG. 2B, the “reports” option 218 comprises sub-options, for example, a “goal report” option 219, a “frequency report” option 220, a “comparison report” option 221, etc.; the “management” option 222 comprises sub-options, for example, a “staff management” option 223, a “department management” option 224, a “district goals” option 225, a “school goals” option 226, a “district resource library” option 227, a “school resource library” option 228, etc.; and the “school management” option 229 comprises a sub-option, for example, a “course management” option 230. Each of the sub-options, for example, the “goal report” option 219, the “frequency report” option 220, the “comparison report” option 221, etc., further comprise a report selector, for example, 219a, 220a, 221a, etc., to allow the internal entities and/or the external entities to generate a PDF file of the reports. The “district resource library” option 227 further comprises a “district resource library management” option 227a that enables management of information resources in the district resource library. The “school resource library” option 228 further comprises a “school resource library management” option 228a that enables management of information resources in the school resource library.

The “goal report” option 219, exemplarily illustrated in FIG. 2B, is a menu item for the district level entity accounts, the school level entity accounts, and the staff level entity accounts. The internal entities can view and print the goal report, herein referred to as a “progress report”, displaying the walk through data selected in the sub-menu. The progress report is a report builder that displays the course type, the grade level, the department, the school, and the district data over a selected date range. In an embodiment, the progress report prints all comments from all the internal entities entered by the internal entities via the GUI of the progress management platform. The staff level entity accounts can only view and print progress reports for the staff internal entities. The school level entity accounts can view and print reports for the staff entities and the school internal entities. The district level entity accounts can view and print reports for the staff level entity accounts, the school level entity accounts, and the other district level entity accounts. The internal entity selects the “goal report” option 219 from the main menu and then selects the “walk through” option 208. The progress management platform then prompts the internal entity to select a type of walk through, for example, “all walk through” (not shown), “walk through by me” (not shown), “walk through by peers” (not shown), etc. The “all walk through” option displays all walk through observations stored in the advisory repository for the goals and dates selected by the internal entity. The “walk through by me” option displays only the walk through observations performed by the internal entity. The “walk through by peers” option displays only the walk through observations performed by the peers of the internal entity.

The internal entity then selects the staff type. The staff types are, for example, certificated, instructional aide, classified, secretarial, administration, custodial, etc. The certificated staff type comprises, for example, classroom teachers. If the internal entity selects the certificated staff type, the progress management platform displays additional selection options for the report type, for example, a grade level, a course, a department, etc. The instructional aide staff type comprises, for example, classroom aides. If the internal entity selects the instructional aide staff type, the progress management platform displays additional selection options for the report type, for example, a grade level, a course, a department, etc. The classified staff type comprises, for example, support personnel, etc. The secretarial staff type comprises, for example, office staff, etc. The administration staff type comprises, for example, principals, assistant principals, etc. The custodial staff type comprises, for example, custodians, maintenance staff, etc.

The internal entity then selects the report type, for example, all, individual staff, department, course, grade level, etc. If the internal entity selects the “all” report type, the progress management platform displays walk through progress reports of all staff members in all staff types. If the internal entity selects the “individual staff” progress report type, the progress management platform displays walk through progress reports of only the selected individual staff member. If the internal entity selects the “department” progress report type, the progress management platform displays walk through progress reports of all the internal entities of only the selected department. If the internal entity selects the “course” progress report type, the progress management platform displays walk through progress reports of all the internal entities of only the selected course. If the internal entity selects the “grade level” progress report type, the progress management platform displays walk through progress reports of all the internal entities of only the selected grade level. After selecting the desired department, course, or grade level, the internal entity then selects a start date and an end date, and other suitable options provided by the progress management platform to obtain the desired walk through progress reports of desired internal entities. The progress reports provided by the progress management platform to the internal entity can be in the form of, for example, charts and comments that display all charts and comments associated with the walk through performed, charts only that display the charts associated with the walk through performed, comments only that display the comments associated with the walk through performed, etc., based on report options, for example, “charts and comments”, “charts only”, “comments only”, etc., selected by the internal entity via the GUI of the progress management platform. Once the internal entity selects the “get report” option, the progress management platform transmits the progress report to the internal entity, for example, via an email notification.

Consider an example where a principal or an administrator wishes to add internal entity accounts to the advisory database to provide them access to the progress management platform. The internal entity logs in to the progress management platform. The internal entity selects the “staff management” option 223 exemplarily illustrated in FIG. 2B, from a main menu provided on the GUI of the progress management platform. In an embodiment, the “staff management” option 223 is provided for a district level entity account or a school level entity account. The “staff management” option 223 further comprises a “staff list” option 223a that provides access to the staff list. The internal entity can input account information of the internal entities of an institution or a district administration via the “school management” option 229 provided on the GUI, in order to enable the internal entities to provide instant feedback to the internal entities. Moreover, the internal entities can input goals in their respective internal entity accounts. The goals inputted by the internal entities populates on the “walk through” option 208 and a formal observation form based on filter settings, for example, individual staff name, staff type, etc., predetermined by the internal entities.

The internal entity selects the “staff management” option 223 from a home page on the GUI. In an embodiment, the internal entity can then select an “add new staff” option from the “staff management” option 223 in order to add each staff member's account information one at a time. The internal entity inputs the first name and last name of the new internal entity to be entered into the advisory repository of the progress management platform. Furthermore, the internal entity can select a staff type. The staff type is, for example, “staff” for most of the employees, “school” for school level entities, “district” for district level entities, etc. If an internal entity is categorized in the staff type, the internal entity can access information stored only in their respective accounts. If the internal entity is categorized in the school type, the internal entity can access all information corresponding to, for example, an individual internal entity, a department, a school, etc. If an internal entity is categorized in the district type, the internal entity can access all information corresponding to, for example, an individual internal entity, a department, a school, a district, etc. After selecting the staff type, the progress management platform prompts internal entity to select a classification category in order to allow the internal entity to peer observe other internal entities in the same classification and populate internal entity specific goals for each of the internal entities categorized in the classification.

Furthermore, the progress management platform prompts the internal entity to input login information for the internal entity account. In an embodiment, the login information is, for example, an email address of the internal entity. The progress management platform also prompts the internal entity to select a level of email notification, for example, “Do not send”, “Send confirmation only”, “Send with walk through data”, etc. The “Do not send” notification level does not send any notification to the internal entity account to indicate any action performed by the progress management platform. The “Send confirmation only” notification level transmits a general email notification to the internal entity informing the internal entity that a walk through or an observation was completed but no information related to the walk through or the observation is included in the email notification. The “Send with walk through data” notification level transmits an email notification to the internal entity with all the information from the walk through or the observation completed by one or more internal entities. The progress management platform then prompts the internal entity to select an “add” option from the home page interface and input an “entity login name” and an “entity password”. In an embodiment, the “entity login name” is an email address of the internal entity. In an embodiment, the internal entity can change the internal entity account password by selecting the “change password” option provided on the login page. After inputting the “entity password”, the progress management platform prompts the internal entity to confirm the “entity password” and select an “update” option. Hence, the internal entity account is activated and can successfully access the progress management platform.

In another embodiment, if the internal entity wishes to add all staff members at the same time, the internal entity selects an “Import Staff Accounts” provided on the home page. The internal entity can repeat the above mentioned steps and update the internal entity account information of each of the staff members in the advisory repository of the progress management platform. The progress management platform prompts the internal entity with, for example, a comma separated value (CSV) file, etc., to add all desired staff members. The progress management platform then uploads and saves the CSV file in the advisory repository.

Consider another example where a principal or an administrator wishes to add a department to the advisory database. The internal entity logs in to the progress management platform and selects the “department management” option 224, exemplarily illustrated in FIG. 2B, from the main menu of the progress management platform. The “department management” option 224 is a menu item for the district level entity accounts. The “department management” option 224 further comprises a “department list” option 224a that provides access to the list of departments in an institution. The departments are various curricular subjects of which courses are a part. The courses are set at the school level. The courses are attached to the departments that are established at the district level. As a result, when a walk through is completed by an internal entity, the internal entity selects a course that is observed and the progress management platform collects the data for both the course and the department. The internal entity selects an “Add New Department” option from the “department management” option 224. The internal entity then inputs the department name into a text field, and then selects an “add” option to add the department to the advisory repository. Similarly, the internal entity can add multiple departments following the above mentioned instructions.

The “district goals management” option 225a, exemplarily illustrated in FIG. 2B, is a menu item for the district level entity accounts. The “district goals” option 225 allows the internal entities to enter as many district goals as they choose. The “district goals” option 225 may be established for every walk through at every site or can be customized for individual grade levels, staff types, or individual courses. The district goals are displayed for any internal entity performing a walk through at any site who selects variables that are linked to the district goals. The internal entity selects the “district goals management” option 225a. The internal entity then selects an “Add New Custom Goal” option, if the internal entity wishes to add a new customized district goal, or selects an “Add New Predefined Goal” option if the internal entity wishes to add a predetermined district goal. In an embodiment, the internal entity assigns a priority number to each of the district goals in order to arrange the district goals in descending or ascending order according to the priority number assigned to each district goal. The priority number field pre-populates with a next available priority number. The internal entity inputs the district goal name into a text box. In an embodiment, the progress management platform prompts the internal entity with a “Include this Goal on the Whole District Report” option in order to allow the internal entity to check or uncheck the option to display or hide the selected district goal from a district progress report generated by the progress management platform. In an embodiment, the internal entity selects the staff type, so the district goals are visible to all internal entities categorized in the staff type. In another embodiment, the internal entity chooses a “Select All” option to display the district goals to the internal entities categorized in all the staff types. In an embodiment, the internal entity selects one or more departments and the district goals become visible to only the internal entities categorized in the departments. In another embodiment, the internal entity chooses a “Select All” option to make the district goals visible to the internal entities of all the departments. In an embodiment, the internal entity selects one or more grade levels to make the district goals visible to all selected grade levels in the district. In an embodiment, the internal entity selects a goal status. The goal status is, for example, active or inactive. In an embodiment, the progress management platform presets the goal status of the district goals to active. In an embodiment, the internal entity can change the goal status of a selected district goal to inactive if the internal entity wishes to maintain and store the data in the advisory repository, but the district goal does not appear while performing the current walk through. The internal entity then selects the “Add” option to upload the district goals on the advisory repository. The internal entity can perform the above mentioned instructions for adding predefined goals.

If the internal entity wishes to add a course to the advisory repository, the internal entity selects the “course management” option 230, exemplarily illustrated in FIG. 2B, from the main menu of the progress management platform. The “course management” option 230 is a menu item for the district level entity accounts and the school level entity accounts. The “course management” option 230 further comprises a “course list” option 230a that provides a list of courses offered by an institution. The courses are individual classes taught at the school level. The courses are attached to the departments that are established at the district level. As a result, when a walk through is completed by an internal entity, the internal entity selects a course observed and the progress management platform collects the data for both the course and the department. If the internal entity has a district level entity account, the internal entity selects a school name to add courses from the “school management” option 229. The internal entity then selects the “Course Management” option 230. In order to add a new course to an existing school course, the internal entity selects an “Add New Course” option and inputs the desired course name into the text field. The internal entity then selects the department the course belongs to and clicks on the “add” option. Similarly, the internal entity can follow the above mentioned instructions to add multiple courses to the school. If the internal entity wishes to add a course to the advisory repository at a school level login, the internal entity selects the “course management” option 230 and follows the same instructions as mentioned above.

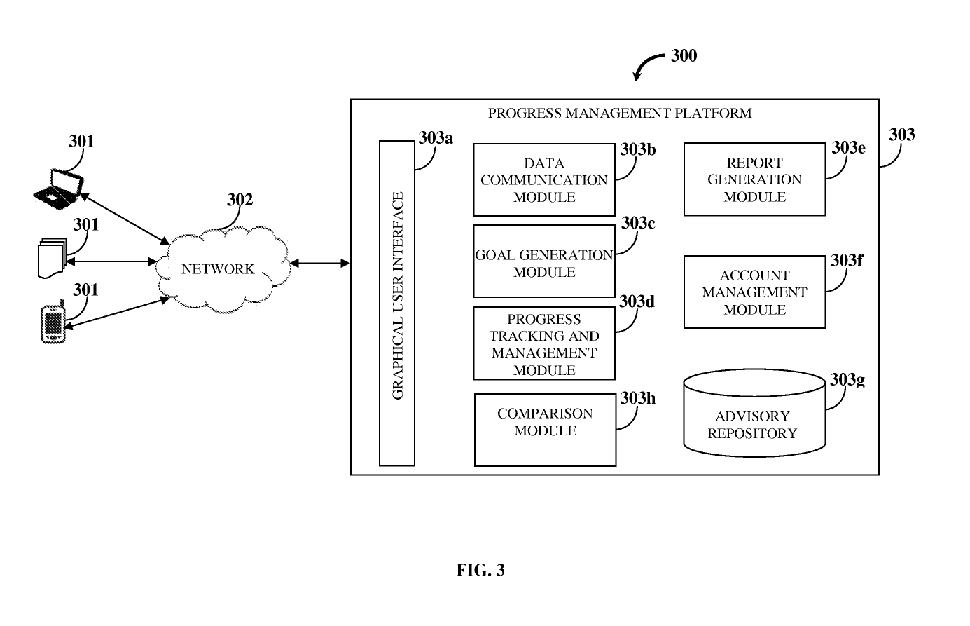

FIG. 3 exemplarily illustrates a computer implemented system 300 for tracking and managing progress of performance goals developed by one or more institutions and one or more district administrations at multiple levels. The computer implemented system 300 disclosed herein comprises a progress management platform 303 accessible by internal entities and external entities of the institutions and the district administrations via a network 302 using entity devices 301. The progress management platform 303 comprises a non-transitory computer readable storage medium and at least one processor communicatively coupled to the non-transitory computer readable storage medium. As used herein, the term “non-transitory computer readable storage medium” refers to all computer readable media, for example, non-volatile media such as optical discs or magnetic disks, volatile media such as a register memory, a processor cache, etc., and transmission media such as wires that constitute a system bus coupled to the processor, except for a transitory, propagating signal. The non-transitory computer readable storage medium stores modules, for example, 303b, 303c, 303d, 303e, 303f, 303h, etc., of the progress management platform 303. The processor is configured to execute the modules, for example, 303b, 303c, 303d, 303e, 303f, 303h, etc., of the progress management platform 303. The progress management platform 303 further comprises a graphical user interface (GUI) 303a, a data communication module 303b, a goal generation module 303c, a progress tracking and management module 303d, a comparison module 303h, a report generation module 303e, an account management module 303f, and an advisory repository 303g.

The data communication module 303b receives goal information and goal criteria at one or more of multiple levels via the GUI 303a. The goal generation module 303c generates one or more modifiable performance goals at one or more of the levels using the received goal information and the goal criteria. The progress tracking and management module 303d tracks progress of the generated modifiable performance goals by collecting and monitoring one or more of observations received on execution of the generated modifiable performance goals by the internal entities at one or more of the levels, self reviews and peer reviews received from the internal entities at one or more of the levels, feedback received from the external entities, etc., via the GUI 303a. The report generation module 303e generates one or more progress reports at one or more of the levels based on the tracked progress of the generated modifiable performance goals to quantify results of the execution of the generated modifiable performance goals for facilitating accountability, professional development, and development of improvement programs. In an embodiment, the goal generation 303c categorizes the generated modifiable performance goals at one or more of the levels into formal goals or informal goals. In an embodiment, the report generation module 303e generates one or more progress reports based on the categorization of the generated modifiable performance goals. In an embodiment, the report generation module 303e generates one or more progress reports based on one or more source parameters, for example, name of the source who performed the observations, type of staff, frequency, etc., associated with one or more of the observations received on the execution of the generated modifiable performance goals by the internal entities at one or more of the levels, the self reviews and the peer reviews received from the internal entities at one or more of the levels, and the feedback received from the external entities.

The comparison module 303h compares one or more of the observations, the peer reviews, and the feedback received for the internal entities with the self reviews performed by the internal entities for facilitating the professional development of the internal entities. The report generation module 303e generates one or more comparison reports based on the comparison. In another embodiment, the report generation module 303e generates one or more comparison reports at one or more of the levels based on one or more of multiple comparison parameters associated with the generated modifiable performance goals for each of the comparison parameters. The data communication module 303b transmits one or more of the generated progress reports and the comparison reports to one or more of the internal entities at one or more of the levels using one or more communication modes over the network 302.

The account management module 303f creates a single entity account for each of the internal entities at one or more of the levels of one or more of the institutions and the district administrations, through which each of the internal entities track and manage the progress of the generated modifiable performance goals associated with each of the internal entities across the institutions and the district administrations. In an embodiment, the account management module 303f provides administrative access of internal entity accounts associated with the internal entities to one or more supervising entities at one or more of the levels of the institutions and the district administrations for accessing and tracking of the progress of the generated modifiable performance goals of the internal entities at one or more of the levels of the institutions and the district administrations.

The advisory repository 303g stores the received goal information, the goal criteria, the generated modifiable performance goals, the received observations, the received self reviews, the received peer reviews, the received feedback, the generated progress reports, the comparison reports, etc. The advisory repository 303g is accessible to the internal entities, the external entities, the institutions, and the district administrations using the entity devices 301 via the network 302 for the development of the improvement programs.

In an embodiment, the progress tracking and management module 303d performs one or more of multiple actions, for example, promotion, sale, review, rating, and modification of information resources for development of the improvement programs. In an embodiment, the progress tracking and management module 303d categorizes the internal entities according to one or more of multiple categorization parameters, for example, skills, qualification, competence, achievements, etc., for the development of the improvement programs at one or more of the levels of the institutions and the district administrations. In an embodiment, the progress tracking and management module 303d generates an accreditation score for each of the internal entities based on an achievement of one or more of the generated modifiable performance goals by the internal entities at one or more of the levels at one or more of the institutions and the district administrations.

In an embodiment, the progress tracking and management module 303d establishes one or more professional learning communities for developing multiple pedagogical methods for professional development, skill acquisition, and skill enhancement of the internal entities at one or more of the levels at the institutions and the district administrations. In another embodiment, the progress tracking and management module 303d organizes and tracks progress of interactive student peer groups and/or interactive instructor-led coaching by the internal entities at the institutions. In another embodiment, the progress tracking and management module 303d provides a calendar interface (not shown) for scheduling improvement programs and/or a periodic assessment of the internal entities. In another embodiment, the progress tracking and management module 303d dynamically generates alerts to notify the internal entities of the schedules of the improvement programs and/or the periodic assessment, and events of one or more of the institutions and the district administrations.

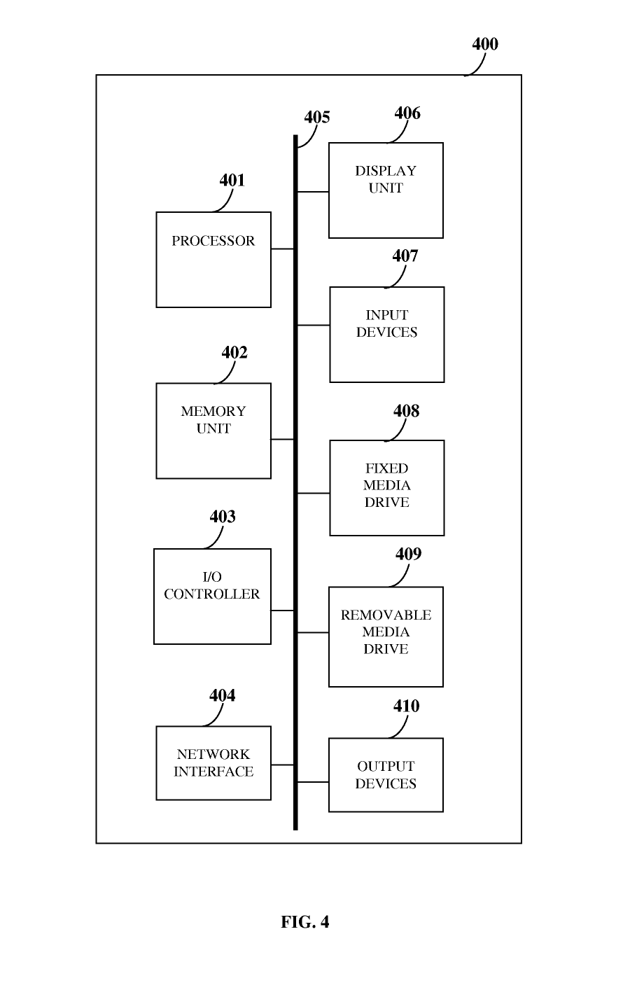

FIG. 4 exemplarily illustrates the architecture of a computer system 400 employed by the progress management platform 303 for tracking and managing progress of performance goals developed by one or more institutions and one or more district administrations at multiple levels. The progress management platform 303 of the computer implemented system 300 exemplarily illustrated in FIG. 3 employs the architecture of the computer system 400 exemplarily illustrated in FIG. 4. The computer system 400 is programmable using a high level computer programming language. The computer system 400 may be implemented using programmed and purposeful hardware.

The progress management platform 303 communicates with the internal entity devices 301 of each of the internal entities, for example, teachers, principals, educational aides, district administrators, etc., and the external entities, for example, parents, guests at the institutions, etc., registered with the progress management platform 303 via a network 302, for example, a short range network or a long range network. The computer system 400 comprises, for example, a processor 401, a non-transitory computer readable storage medium such as a memory unit 402 for storing programs and data, an input/output (I/O) controller 403, a network interface 404, a data bus 405, a display unit 406, input devices 407, a fixed media drive 408, a removable media drive 409 for receiving removable media, output devices 410, etc.

The processor 401 refers to any one or more microprocessors, central processing unit (CPU) devices, finite state machines, computers, microcontrollers, digital signal processors, logic, a logic device, an electronic circuit, an application specific integrated circuit (ASIC), a field-programmable gate array (FPGA), a chip, etc., or any combination thereof, capable of executing computer programs or a series of commands, instructions, or state transitions. The processor 401 may also be implemented as a processor set comprising, for example, a general purpose microprocessor and a math or graphics co-processor. The processor 401 is selected, for example, from the Intel® processors such as the Itanium® microprocessor or the Pentium® processors, Advanced Micro Devices (AMD®) processors such as the Athlon® processor, UltraSPARC® processors, microSPARC™ processors, Hp® processors, International Business Machines (IBM®) processors such as the PowerPC® microprocessor, the MIPS® reduced instruction set computer (RISC) processor of MIPS Technologies, Inc., RISC based computer processors of ARM Holdings, Motorola® processors, Qualcomm® processors, etc. The progress management platform 303 disclosed herein is not limited to a computer system 400 employing a processor 401. The computer system 400 may also employ a controller or a microcontroller. The processor 401 executes the modules, for example, 303b, 303c, 303d, 303e, 303f, 303h, etc., of the progress management platform 303.

The memory unit 402 is used for storing programs, applications, and data. For example, the data communication module 303b, the goal generation module 303c, the progress tracking and management module 303d, the report generation module 303e, the account management module 303f, the comparison module 303h, etc., of the progress management platform 303 are stored in the memory unit 402 of the computer system 400. The memory unit 402 is, for example, a random access memory (RAM) or another type of dynamic storage device that stores information and instructions for execution by the processor 401. The memory unit 402 also stores temporary variables and other intermediate information used during execution of the instructions by the processor 401. The computer system 400 further comprises a read only memory (ROM) or another type of static storage device that stores static information and instructions for the processor 401.

The network interface 404 enables connection of the computer system 400 to the network 302. For example, the progress management platform 303 connects to the network 302 via the network interface 404. In an embodiment, the network interface 404 is provided as an interface card also referred to as a line card. The network interface 404 comprises, for example, one or more of an infrared (IR) interface, an interface implementing Wi-Fi® of the Wireless Ethernet Compatibility Alliance, Inc., a universal serial bus (USB) interface, a FireWire® interface of Apple, Inc., an Ethernet interface, a frame relay interface, a cable interface, a digital subscriber line (DSL) interface, a token ring interface, a peripheral controller interconnect (PCI) interface, a local area network (LAN) interface, a wide area network (WAN) interface, interfaces using serial protocols, interfaces using parallel protocols, and Ethernet communication interfaces, asynchronous transfer mode (ATM) interfaces, a high speed serial interface (HSSI), a fiber distributed data interface (FDDI), interfaces based on transmission control protocol (TCP)/internet protocol (IP), interfaces based on wireless communications technology such as satellite technology, radio frequency (RF) technology, near field communication, etc. The I/O controller 403 controls input actions and output actions performed by the progress management platform 303. The data bus 405 permits communications between the modules, for example, 303a, 303b, 303c, 303d, 303e, 303f, 303g, 303h, etc., of the progress management platform 303.

The display unit 406, via the graphical user interface (GUI) 303a, displays information, display interfaces, user interface elements such as text fields, checkboxes, text boxes, windows, etc., for allowing an internal entity of an institution or an district administration to enter the goal information and the goal criteria, an external entity to enter feedback for the internal entities of one or more institutions or one or more district administration, etc. The display unit 406 comprises, for example, a liquid crystal display, a plasma display, an organic light emitting diode (OLED) based display, etc. The input devices 407 are used for inputting data into the computer system 400. The input devices 407 are, for example, a keyboard such as an alphanumeric keyboard, a microphone, a joystick, a pointing device such as a computer mouse, a touch pad, a light pen, a physical button, a touch sensitive display device, a track ball, a pointing stick, any device capable of sensing a tactile input, etc.

Computer applications and programs are used for operating the computer system 400. The programs are loaded onto the fixed media drive 408 and into the memory unit 402 of the computer system 400 via the removable media drive 409. In an embodiment, the computer applications and programs may be loaded directly via the network 302. Computer applications and programs are executed by double clicking a related icon displayed on the display unit 406 using one of the input devices 407. The output devices 410 output the results of operations performed by the progress management platform 303. For example, the progress management platform 303 provides customized progress reports and comparison reports to the internal entities and the external entities using the output devices 410. The progress management platform 303 displays the generated progress reports and the comparison reports using the output devices 410.

The processor 401 executes an operating system, for example, the Linux® operating system, the Unix® operating system, any version of the Microsoft® Windows® operating system, the Mac OS of Apple Inc., the IBM® OS/2, VxWorks® of Wind River Systems, inc., QNX Neutrino® developed by QNX Software Systems Ltd., the Palm OS®, the Solaris operating system developed by Sun Microsystems, Inc., the Android operating system, the Windows Phone® operating system of Microsoft Corporation, the BlackBerry® operating system of Research in Motion Limited, the iOS operating system of Apple Inc., the Symbian® operating system of Symbian Foundation Limited, etc. The computer system 400 employs the operating system for performing multiple tasks. The operating system is responsible for management and coordination of activities and sharing of resources of the computer system 400. The operating system further manages security of the computer system 400, peripheral devices connected to the computer system 400, and network connections. The operating system employed on the computer system 400 recognizes, for example, inputs provided by an administrator of the progress management platform 303 using one of the input devices 407, the output display, files, and directories stored locally on the fixed media drive 408, for example, a hard drive. The operating system on the computer system 400 executes different programs using the processor 401. The processor 401 and the operating system together define a computer platform for which application programs in high level programming languages are written.

The processor 401 retrieves instructions for executing the modules, for example, 303b, 303c, 303d, 303e, 303f, 303h, etc., of the progress management platform 303 from the memory unit 402. A program counter determines the location of the instructions in the memory unit 402. The program counter stores a number that identifies the current position in the program of each of the modules, for example, 303b, 303c, 303d, 303e, 303f, 303h, etc., of the progress management platform 303. The instructions fetched by the processor 401 from the memory unit 402 after being processed are decoded. The instructions are stored in an instruction register in the processor 401. After processing and decoding, the processor 401 executes the instructions. For example, the data communication module 303b defines instructions for receiving goal information and goal criteria at one or more of the levels via the GUI 303a. The goal generation module 303c defines instructions for generating one or more modifiable performance goals at one or more of the levels using the received goal information and the goal criteria. In an embodiment, the goal generation module 303c defines instructions for categorizing the generated modifiable performance goals at one or more of the levels into formal goals or informal goals. The progress tracking and management module 303d defines instructions for collecting and monitoring one or more of observations received on execution of the generated modifiable performance goals by the internal entities at one or more of the levels, self reviews and peer reviews received from the internal entities at one or more of the levels, feedback received from the external entities, etc., via the GUI 303a. The report generation module 303e defines instructions for generating one or more progress reports at one or more of the levels based on the tracked progress of the generated modifiable performance goals to quantify results of the execution of the generated modifiable performance goals for facilitating accountability, professional development, and development of improvement programs.

In an embodiment, the report generation module 303e defines instructions for generating one or more progress reports based on the categorization of the generated modifiable performance goals. In another embodiment, the report generation module 303e defines instructions for generating one or more progress reports based on one or more source parameters associated with one or more of the observations received on the execution of the generated modifiable performance goals by the internal entities at one or more of the levels, the self reviews and the peer reviews received from the internal entities at one or more of the levels, and the feedback received from the external entities.

In another embodiment, the report generation module 303e defines instructions for generating one or more progress reports based on one or more of formal observations and informal observations of the generated modifiable performance goals received from one or more of the internal entities at one or more of the levels and the external entities. In an embodiment, the comparison module 303h defines instructions for comparing one or more of the observations, the peer reviews, and the feedback received for the internal entities with the self reviews performed by the internal entities for facilitating the professional development of the internal entities. In an embodiment, the report generation module 303e defines instructions for generating one or more comparison reports based on the comparison. In an embodiment, the report generation module 303e defines instructions for generating one or more comparison reports at one or more of the levels based on one or more comparison parameters associated with the generated modifiable performance goals for each of the comparison parameters. In an embodiment, data communication module 303b defines instructions for transmitting one or more of the generated progress reports and the comparison reports to one or more of the internal entities at one or more of the levels using one or more communication modes over the network 302.

In an embodiment, the account management module 303f defines instructions for creating single entity account for each of the internal entities at one or more of the levels of the institutions and the district administrations. In another embodiment, the account management module 303f defines instructions for providing administrative access of internal entity accounts associated with the internal entities to one or more supervising entities at one or more of the levels of the institutions and the district administrations for accessing and tracking the progress of the generated modifiable performance goals of the internal entities at one or more of the levels of the institutions and the district administrations.

Furthermore, the progress tracking and management module 303d defines instructions for performing one or more of multiple actions associated with information resources for development of improvement programs. Furthermore, the progress tracking and management module 303d defines instructions for categorizing the internal entities according to one or more categorization parameters for the development of the improvement programs at one or more of the levels of the institutions and the district administrations. Furthermore, the progress tracking and management module 303d defines instructions for generating an accreditation score for each of the internal entities based on an achievement of the generated modifiable performance goals by the internal entities at one or more of the levels at the institutions and the district administrations. Furthermore, the progress tracking and management module 303d defines instructions for establishing one or more professional learning communities for developing multiple pedagogical methods for professional development, skill acquisition, and skill enhancement of the internal entities at one or more of the levels at the institutions and the district administrations.

Furthermore, the progress tracking and management module 303d defines instructions for organizing and tracking progress of one or more of interactive student peer groups and interactive instructor-led coaching by the internal entities at the institutions. Furthermore, the progress tracking and management module 303d defines instructions for providing a calendar interface for scheduling improvement programs and/or a periodic assessment of the internal entities. The progress tracking and management module 303d defines instructions for dynamically generating alerts to notify the internal entities of one or more of schedules of the improvement programs and the periodic assessment, and events of the institutions and the district administrations.

The processor 401 of the computer system 400 employed by the progress management platform 303 retrieves the instructions defined by the data communication module 303b, the goal generation module 303c, the progress tracking and management module 303d, the report generation module 303e, the account management module 303f, the comparison module 303h, etc., of the progress management platform 303, and executes the instructions, thereby performing one or more processes defined by those instructions.

At the time of execution, the instructions stored in the instruction register are examined to determine the operations to be performed. The processor 401 then performs the specified operations. The operations comprise arithmetic operations and logic operations. The operating system performs multiple routines for performing a number of tasks required to assign the input devices 407, the output devices 410, and memory for execution of the modules, for example, 303b, 303c, 303d, 303e, 303f, 303h, etc., of the progress management platform 303. The tasks performed by the operating system comprise, for example, assigning memory to the modules, for example, 303b, 303c, 303d, 303e, 303f, 303h, etc., of the progress management platform 303, and to data used by the progress management platform 303, moving data between the memory unit 402 and disk units, and handling input/output operations. The operating system performs the tasks on request by the operations and after performing the tasks, the operating system transfers the execution control back to the processor 401. The processor 401 continues the execution to obtain one or more outputs. The outputs of the execution of the modules, for example, 303b, 303c, 303d, 303e, 303f, 303h, etc., of the progress management platform 303 are displayed on the display unit 406.

For purposes of illustration, the detailed description refers to the progress management platform 303 being run locally on the computer system 400; however the scope of the computer implemented method and system 300 disclosed herein is not limited to the progress management platform 303 being run locally on the computer system 400 via the operating system and the processor 401, but may be extended to run remotely over the network 302 by employing a web browser and a remote server, a mobile phone, or other electronic devices. One or more portions of the computer system 400 may be distributed across one or more computer systems (not shown) coupled to the network 302.

Disclosed herein is also a computer program product comprising a non-transitory computer readable storage medium that stores computer program codes comprising instructions executable by at least one processor 401 for tracking and managing progress of performance goals developed by one or more institutions and/or district administrations at different levels. The computer program product disclosed herein comprises a first computer program code for receiving goal information and goal criteria at one or more levels via the GUI 303a; a second computer program code for generating one or more modifiable performance goals at one or more of the levels using the received goal information and the goal criteria; a third computer program code for tracking progress of the generated modifiable performance goals by collecting and monitoring one or more of observations received on execution of the generated modifiable performance goals by the internal entities at one or more levels, self reviews and peer reviews received from the internal entities at one or more levels, and feedback received from the external entities via the GUI 303a; a fourth computer program code for generating one or more progress reports at one or more of the levels based on the tracked progress of the generated modifiable performance goals to quantify results of the execution of the generated modifiable performance goals for facilitating accountability, professional development, and development of improvement programs. The computer program product disclosed herein further comprises one or more additional computer program codes for performing additional steps that may be required and contemplated for tracking and managing progress of the performance goals developed by one or more institutions and/or district administrations at multiple levels. In an embodiment, a single piece of computer program code comprising computer executable instructions performs one or more steps of the computer implemented method disclosed herein for tracking and managing progress of performance goals developed by one or more institutions and/or district administrations at multiple levels.

The computer program codes comprising computer executable instructions are embodied on the non-transitory computer readable storage medium. The processor 401 of the computer system 400 retrieves these computer executable instructions and executes them. When the computer executable instructions are executed by the processor 401, the computer executable instructions cause the processor 401 to perform the steps of the computer implemented method for tracking and managing progress of performance goals developed by one or more institutions and/or district administrations at multiple levels.

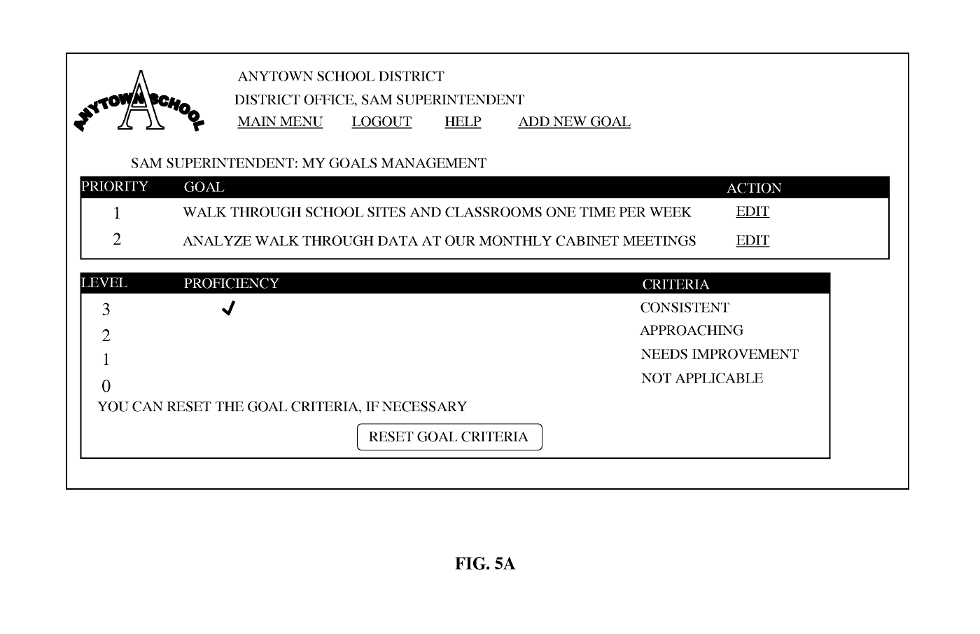

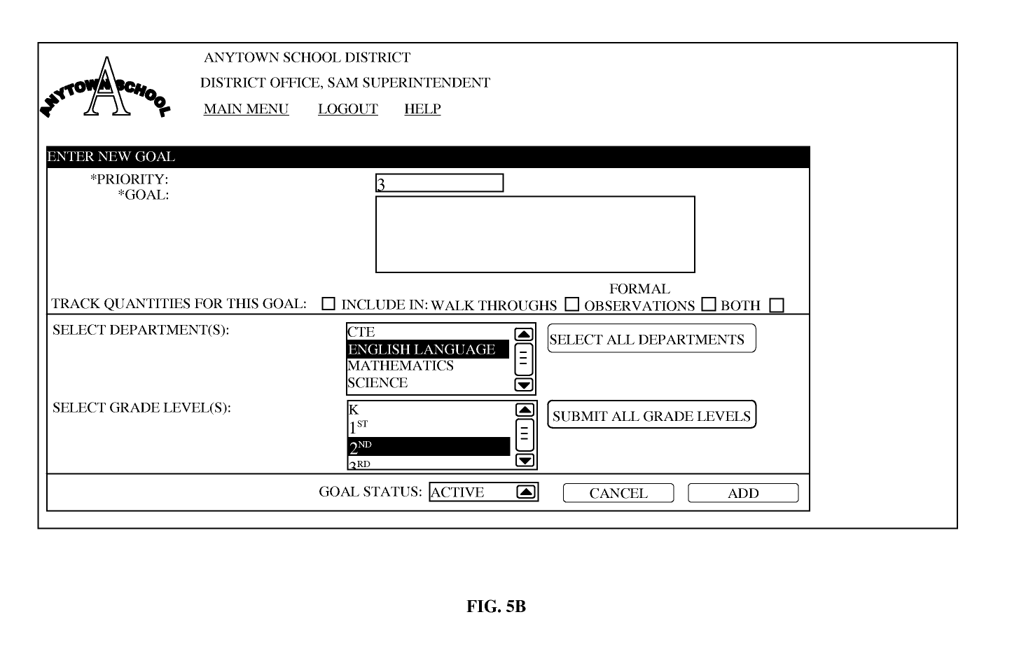

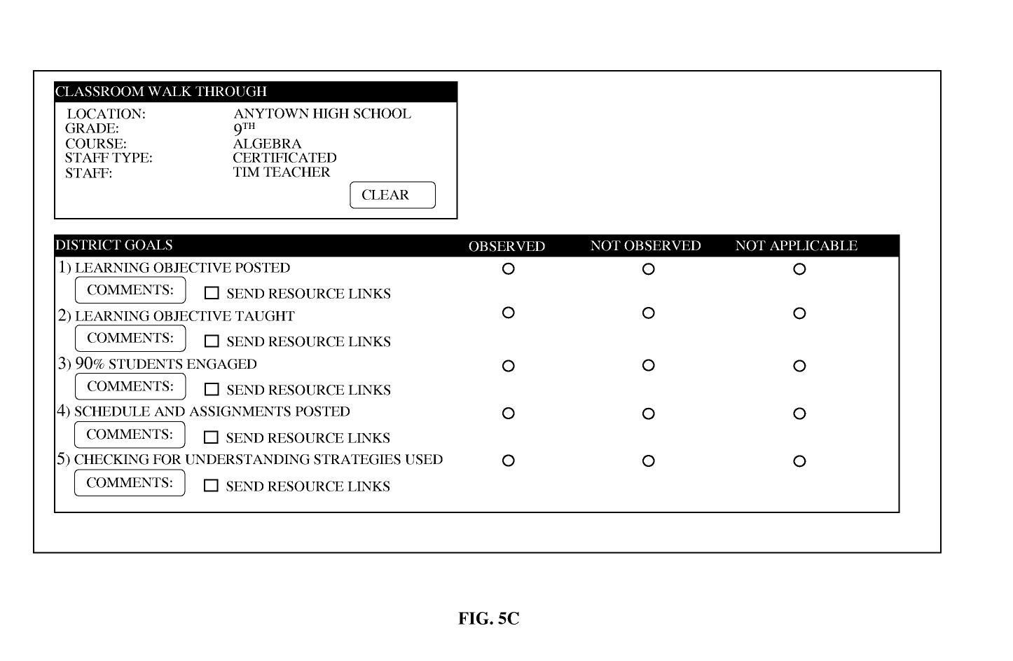

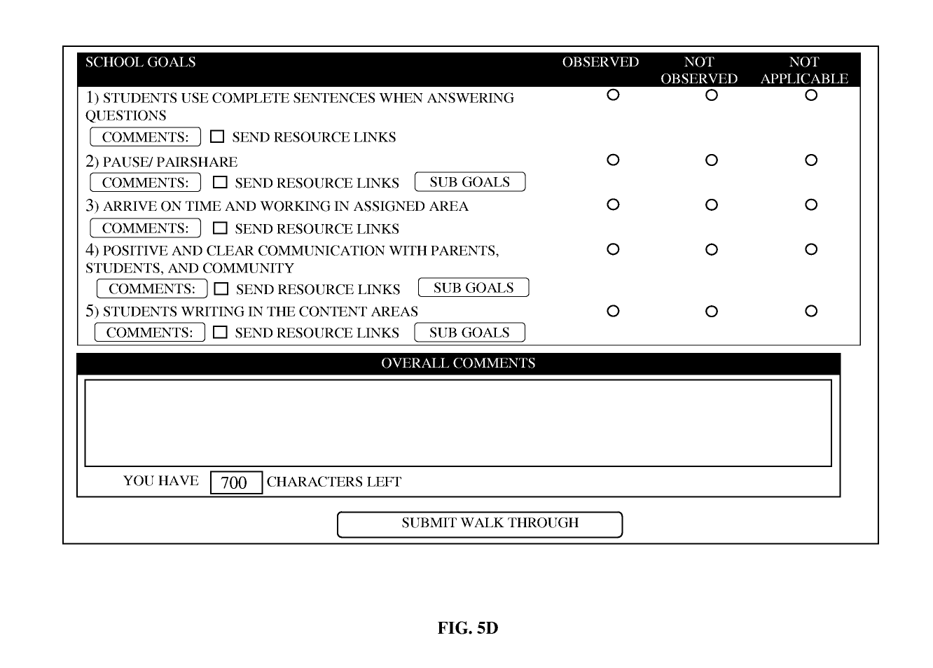

FIGS. 5A-5B exemplarily illustrate screenshots of a graphical user interface (GUI) 303a provided by the progress management platform 303 exemplarily illustrated in FIG. 3, for generating performance goals based on goal information and goal criteria. Consider an example where a superintendent of a district administration, Sam, accesses the progress management platform 303 to perform observations of one or more staff members of one or more educational institutions at a district level. The staff members comprise, for example, a teacher, a secretary, a librarian, etc., of the educational institution. The progress management platform 303 requests Sam to enter a password for logging into the progress management platform 303 via the GUI 303a. After successful log in, the progress management platform 303 displays main menu content on the GUI 303a. The main menu comprises multiple options, for example, a “reports” option 218, a “walk through” option 208, a “management” option 222, a selection dropdown menu to select an educational institution, etc., as disclosed in the detailed description of FIGS. 2A-2B. Each option provides links, for example, the “reports” option 218 provides links to access progress reports, walk through reports, comparison reports, etc. The “walk through” option 208 provides links to access, for example, a classroom walk through, a general walk through, a peer walk through, a link to access self reviews, etc. The “management” option 222 exemplarily illustrated in FIG. 2B, provides links, for example, to access district goals management, department management, staff management, etc. Moreover, the main menu provides, for example, a “school management” option 229 exemplarily illustrated in FIG. 2B, where Sam can view a number of educational institutions when he clicks on the dropdown menu.

Sam may access his performance goals by clicking on a “my goals” link provided on the GUI 303a. The progress management platform 303 enables Sam to view existing goal information and goal criteria, edit the goal information and the goal criteria, add new the goal information and the goal criteria, select one or more department types for the added goal information and the goal criteria from a dropdown selection menu, select one or more grade levels for the added goal information and goal criteria from a dropdown selection menu, select a goal status for the added goal information and goal criteria from a dropdown selection menu, etc., as exemplarily illustrated in FIGS. 5A-5B. When Sam enters new goal information and new goal criteria via the GUI 303a, the progress management platform 303 requests Sam to save the goal information and the goal criteria via the GUI 303a. When the goal information and the goal criteria are saved, the progress management platform 303 generates the performance goals for the newly added goal information and the newly added goal criteria.

FIGS. 5C-5D exemplarily illustrate screenshots of a graphical user interface (GUI) 303a provided by the progress management platform 303 exemplarily illustrated in FIG. 3, for tracking and managing progress of performance goals. Consider an example where Sam, the superintendent of the district administration, requests the progress management platform 303 to allow him to perform an observation, for example, a classroom walk through observation. The progress management platform 303 requests for information such as name of the educational institution, a grade level, a name of a course, type of a staff member, for example, a certificated member, an instructional aide member, a custodial member, etc., and the staff to be observed for performing the observation. Sam chooses to perform observations on a certificated teacher, for example, Tim, a grade 9 algebra teacher. The information received by the progress management platform 303 is, for example, a selection with the location being Anytown high school, the grade level being 9, the name of the course being algebra, the staff type being certificated, and the staff to be observed being Tim as exemplarily illustrated in FIG. 5C.

Once the information provided by Sam is received by the progress management platform 303 via the GUI 303a, the progress management platform 303 displays a screen for allowing Sam to enter his observations. The progress management platform 303 displays the details of the staff member being observed and the performance goals against which Tim is to be observed. The progress management platform 303 allows Sam to choose whether the performance goals generated for Tim were observed, not observed, or not applicable, as exemplarily illustrated in FIGS. 5C-5D. The progress management platform 303 further enables Sam to enter comments associated with the performance goals in a text box exemplarily illustrated in FIG. 5D. Sam can enter observations based on the performance goals developed by both the educational institution and the district administration. In an embodiment, the progress management platform 303 generates classroom walk through progress reports once Sam submits the observations on Tim to the progress management platform 303, for example, for determining a future change in the development of improvement programs. The progress management platform 303 transmits progress reports electronically to Tim and Sam.

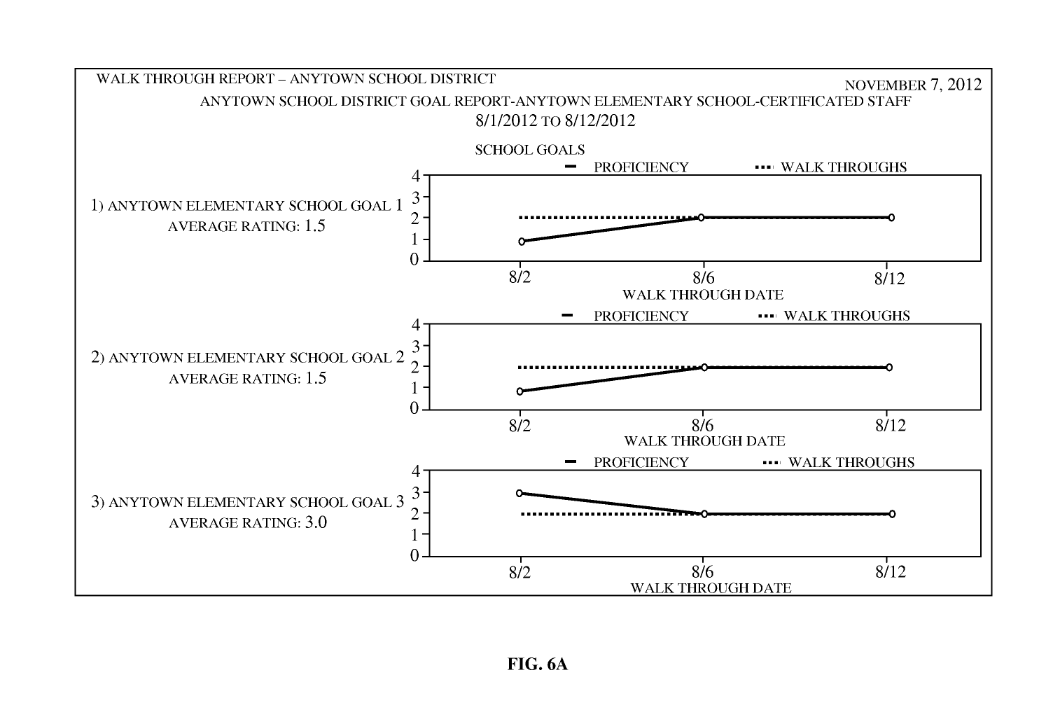

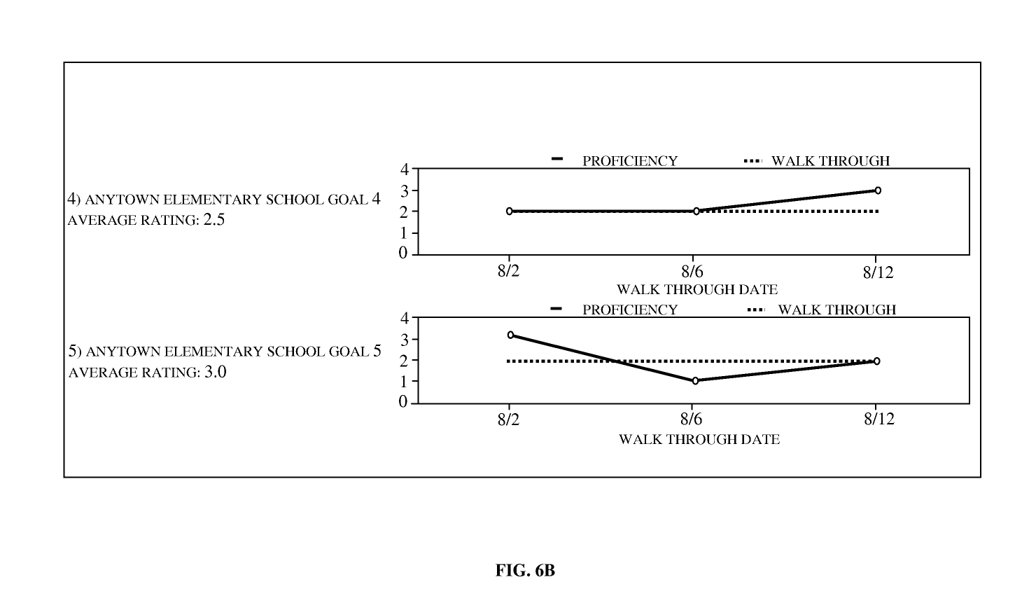

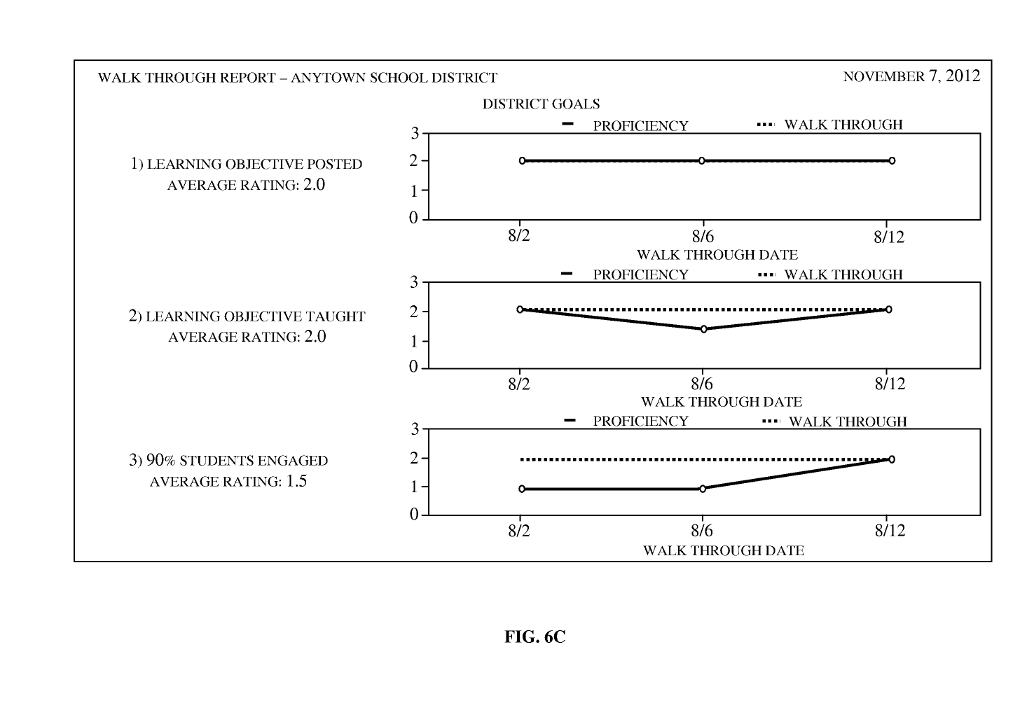

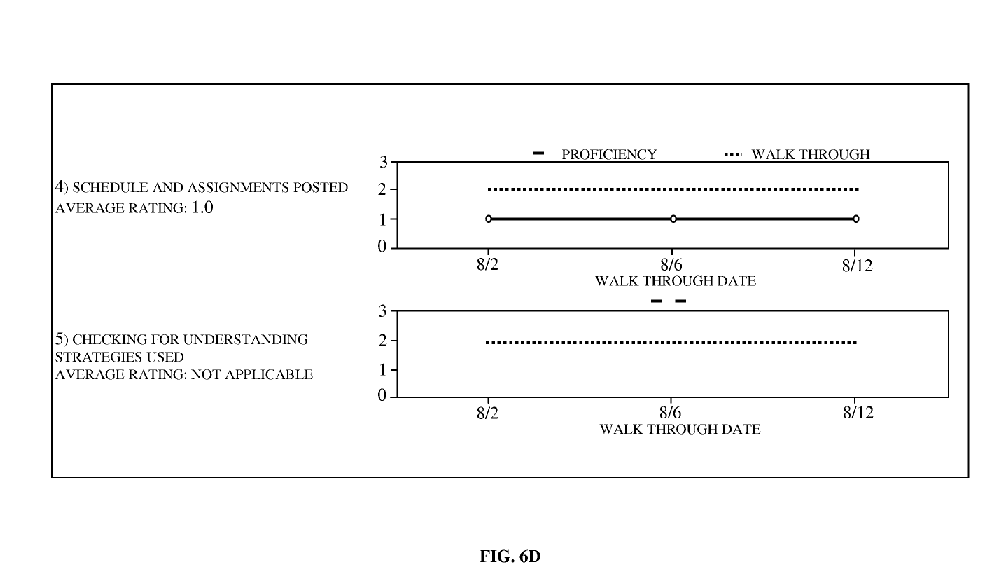

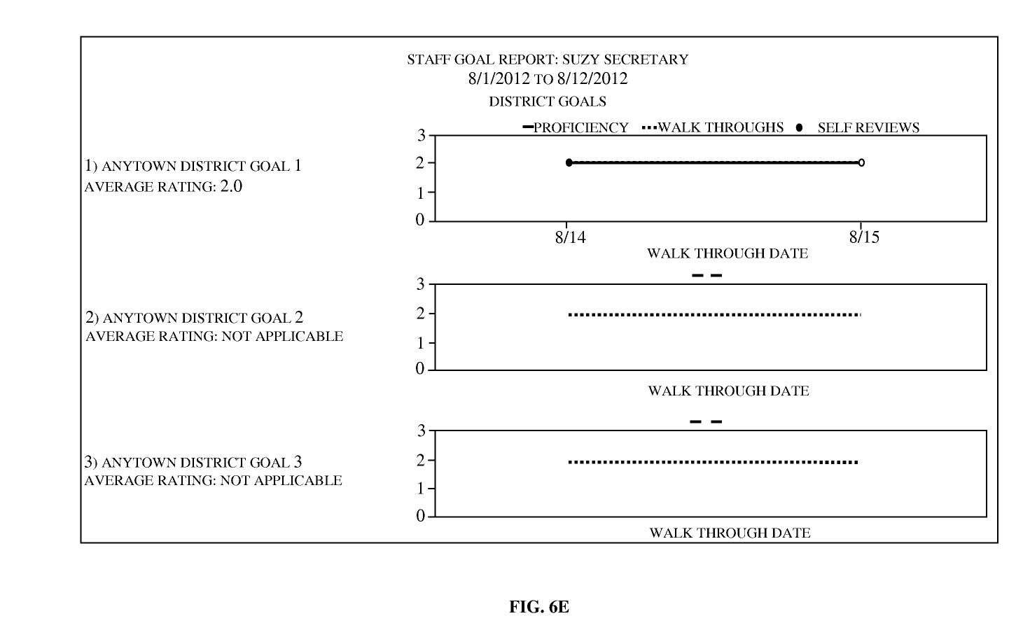

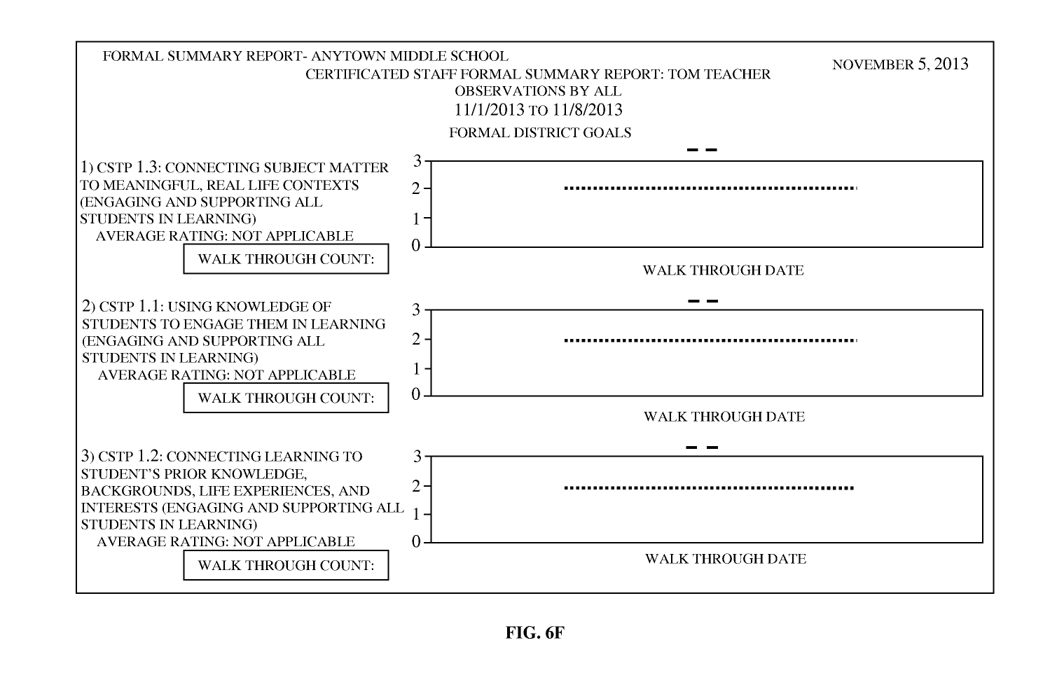

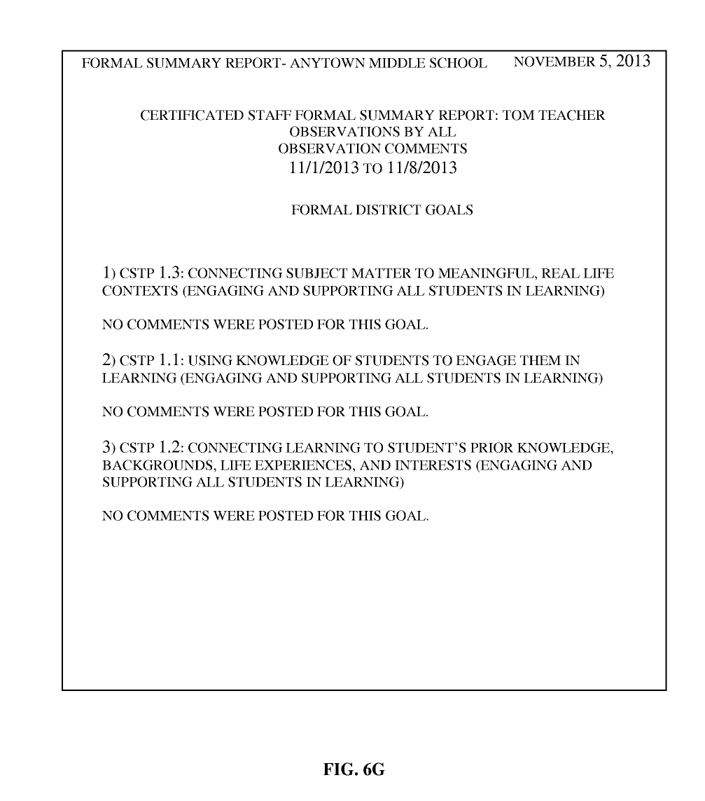

FIGS. 6A-6E exemplarily illustrate progress reports generated by the progress management platform 303 exemplarily illustrated in FIG. 3. In an embodiment, the progress management platform 303 enables Sam to access the progress reports selectively, for example, based on a location of the educational institution, the grade level, a name of a course, a type of the staff member, and the staff to be observed. The progress management platform 303 also generates progress reports based on a date range selected by Sam. For example, if Sam requests a progress report starting from Aug. 1, 2012 to Aug. 12, 2012, the progress management platform 303 generates progress reports for the requested date range. The generated progress report comprises graphical information, for example, a graph, a chart, etc., showing the progress of the educational institution, for example, Anytown Elementary School and the observations made in the requested date range, as exemplarily illustrated in FIGS. 6A-6B. The graphical representations of the observations indicate the walk through observations and proficiency observations made with respect to the performance goals at a school level against the walk through date selected. FIGS. 6C-6D exemplarily illustrate walk through observations and proficiency observations made with respect to the performance goals at a district level against the walk through date selected.

The progress management platform 303 generates progress reports based on a selection of a type of staff member being observed, for example, staff members belonging to a certificated group, an instructional aide group, an administration group, a secretarial group, a maintenance group, etc. For example, the progress management platform 303 generates progress reports for a staff member, for example, Suzy, a secretary in one of the educational institutions requested by a senior member of the educational institution or the district administration as exemplarily illustrated in FIG. 6E. The progress management platform 303 also enables the senior member, for example, Sam, the superintendent to choose a date range for the generation of progress reports. The progress management platform 303 then generates progress reports for the date range, for example, from Aug. 1, 2012 to Aug. 22, 2012. The progress management platform 303 also generates graphical representations of the walk through observations performed on Suzy with respect to the generated performance goals developed by the district administrations. The observations performed represent the walk through observations, the self reviews against the proficiency observations, etc.

FIGS. 6F-6G exemplarily illustrate a formal summary report generated by the progress management platform 303 exemplarily illustrated in FIG. 3. The formal summary report is generated based on formal district goals as exemplarily illustrated in FIG. 6F. Consider an example where a teacher Tom wishes to generate a formal summary report of observations conducted by the internal entities at all levels and the external entities based on tracked progress of formal district goals. Tom selects the “formal observation” option 212 exemplarily illustrated in FIG. 2A from the main menu and then selects the “formal summary report” option 217 exemplarily illustrated in FIG. 2A. Tom then selects a date range, for example, from Nov. 1, 2013 to Nov. 8, 2013. On selecting a “get report” option (not shown) provided on the GUI 303a, the progress management platform 303 displays the formal summary report comprising charts or graphical representations and comments as exemplarily illustrated in FIGS. 6F-6G.

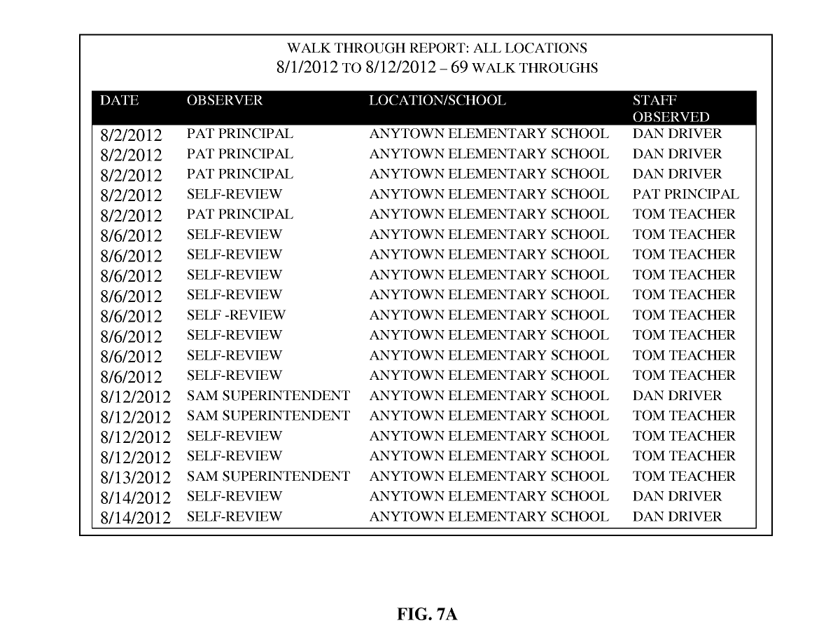

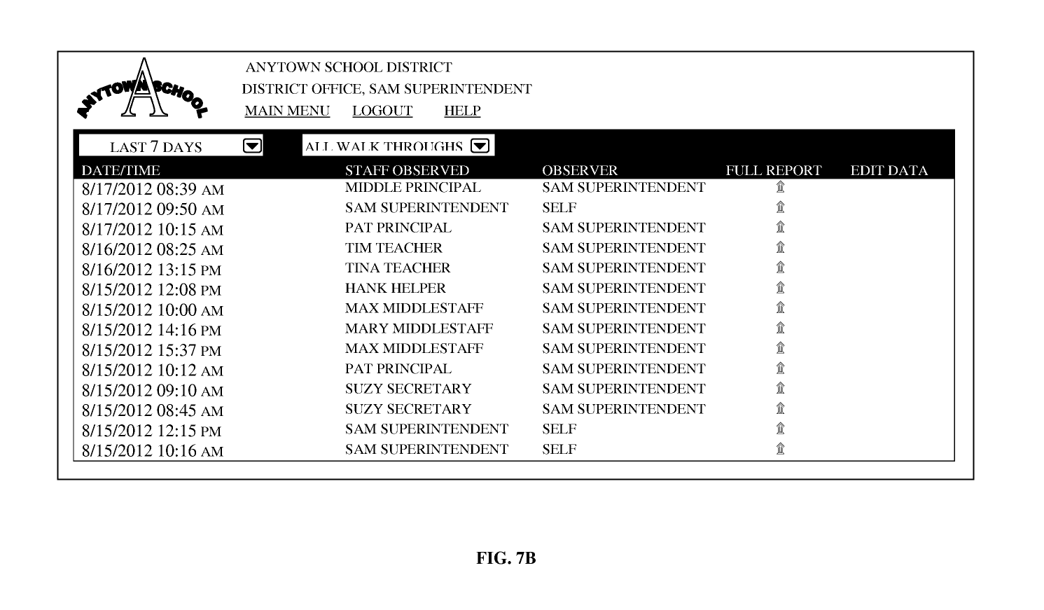

FIGS. 7A-7B exemplarily illustrate lists of walk through progress reports generated by the progress management platform 303 exemplarily illustrated in FIG. 3. FIG. 7A exemplarily illustrates a walk through progress report generated by the progress management platform 303 for all locations. The walk through progress report represents the entire walk through observations performed by senior members of the institutions and the district administrations. Consider an example where Sam requests the progress management platform 303 to generate a walk through progress report starting from Aug. 1, 2012 till Aug. 22, 2012. The progress management platform 303 generates a list of the entire walk through observations performed by senior members of the institutions and the district administrations. The progress report generated comprises information, for example, a date, a name of the observer, a name of the educational institution or the district administration, and a name of the staff member who was observed. In an embodiment, the progress management platform 303 also displays the total number of walk through observations performed in a particular date range. In another embodiment, the progress management platform 303 displays the walk through observations performed by a particular member of the institution and the district administration. For example, a “my walk through” progress report option provided by the progress management platform 303 lists the progress reports comprising the walk through observations performed, for example, by Sam in a particular date range, for example, the last 7 days as exemplarily illustrated in FIG. 7B. The progress management platform 303 displays, for example, the list of the dates on which the observations were made, the list of the staff members being observed, the name of the observer, for example, Sam, a link to view a full progress report, and a link to edit data contained in the progress reports. The full progress report comprises, for example, the comments and inputs provided by the observer. The progress management platform 303 also displays the self reviews performed by Sam for himself. If an internal entity wishes to view a progress report, the internal entity can select a report icon for, for example, Sam superintendent from the list, as exemplarily illustrated in FIG. 7B.

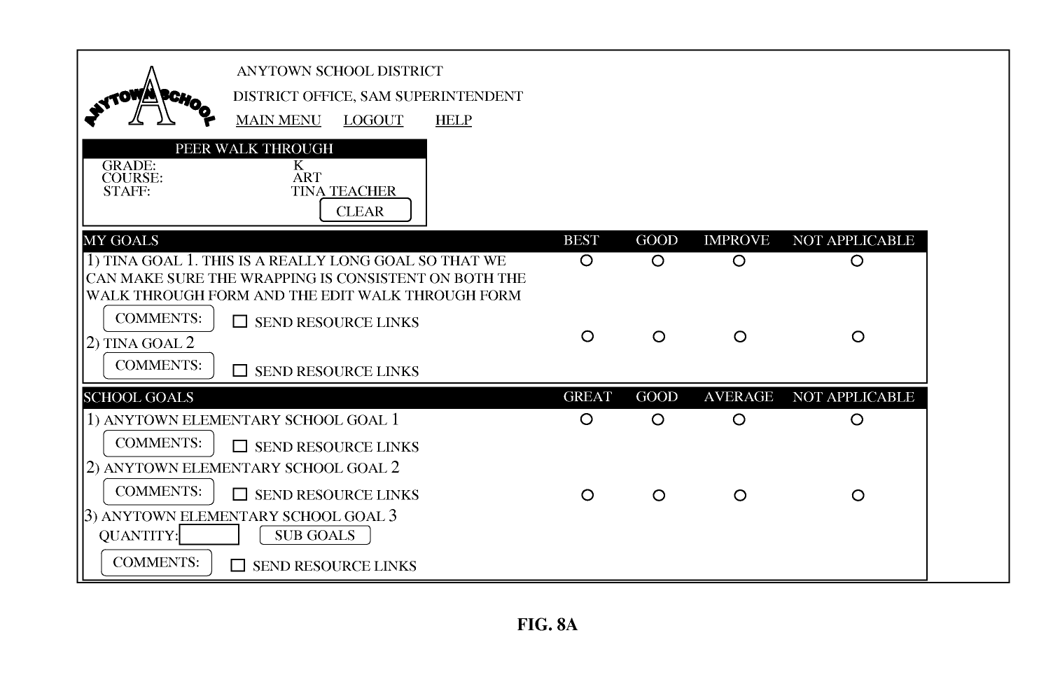

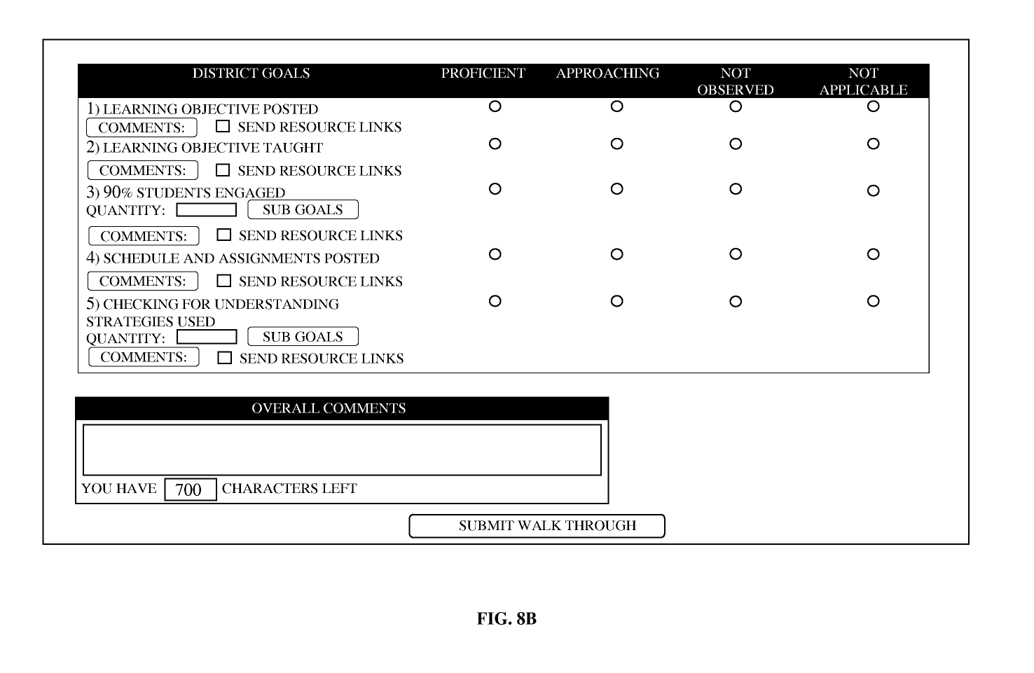

FIGS. 8A-8B exemplarily illustrate screenshots of a graphical user interface (GUI) 303a provided by the progress management platform 303 exemplarily illustrated in FIG. 3, for performing a peer review. The progress management platform 303 also allows internal entities to perform peer walk through observations. For example, Sam is able to perform observations on his peers with respect to the generated performance goals developed by the district administrations and the institutions through the progress management platform 303. Sam can observe the performance of his colleague Tina based on the performance goals generated by Tina herself, her school, and the district of her school. The progress management platform 303 provides option buttons on the GUI 303a to allow Sam to enter his observations. Sam may also enter comments in an “overall comments” text box on the GUI 303a and submit the peer walk through report to the progress management platform 303.

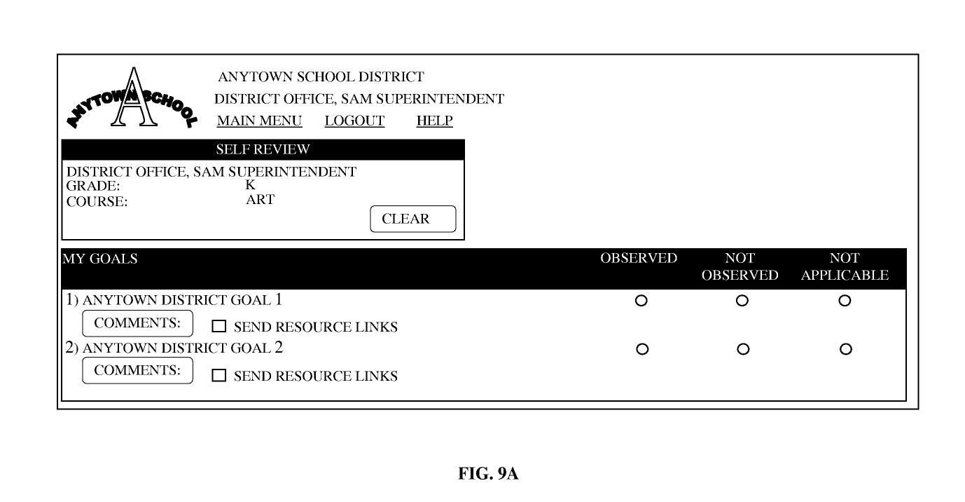

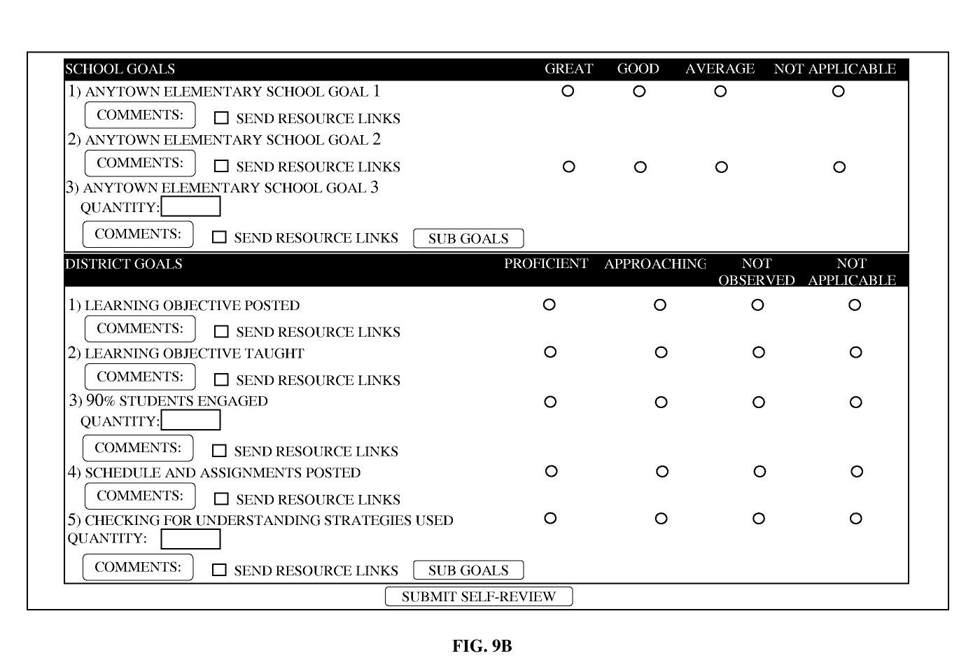

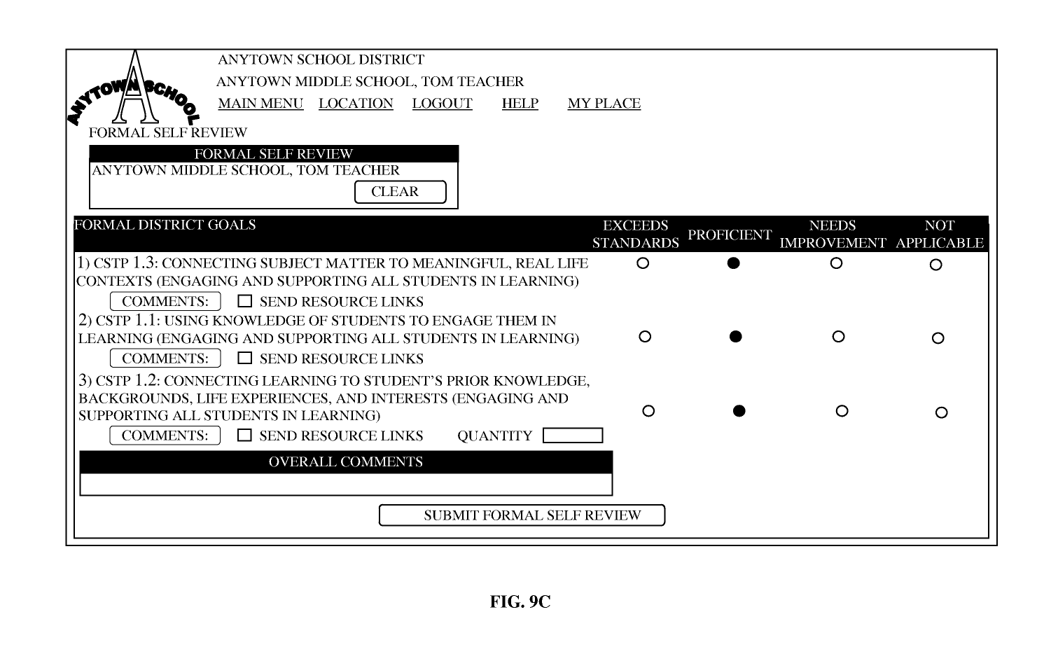

FIGS. 9A-9B exemplarily illustrate screenshots of a graphical user interface (GUI) 303a provided by the progress management platform 303 exemplarily illustrated in FIG. 3, for performing a self review. The progress management platform 303 further allows self reviews to be performed. For example, the progress management platform 303 allows Sam, the superintendent of the district administration to perform a self review by observing his execution of performance goals generated for him by the progress management platform 303 based on the goal information and the goal criteria developed by Sam himself, goals generated by his school, and goals generated by the district to which his school belongs. The progress management platform 303 further allows Sam to select whether the generated performance goals were observed or not observed by him or not applicable to him. Once the self review is complete and submitted to the progress management platform 303, the progress management platform 303 generates a self review progress report for Sam and stores the self review progress report in the advisory repository 303g exemplarily illustrated in FIG. 3.

FIG. 9C exemplarily illustrates a screenshot of a graphical user interface (GUI) 303a provided by the progress management platform 303 exemplarily illustrated in FIG. 3, for performing a formal self review. Consider an example where a teacher Tom wishes to perform the formal self review. Tom selects the “my place” option 201 exemplarily illustrated in FIG. 2A from the main menu and then selects the “formal self review” option 205 exemplarily illustrated in FIG. 2A. The progress management platform 303 provides Tom with formal district goals. Tom can add comments to each of the formal district goals by selecting a “comments” option provided on the GUI 303a or can add comments for the entire formal self review by selecting an “overall comments” option provided on the GUI 303a. Once Tom has completed the formal self review for the formal district goals, he can select a “submit formal self review” option provided on the GUI 303a of the progress management platform 303 to submit the formal self review to the progress management platform 303.

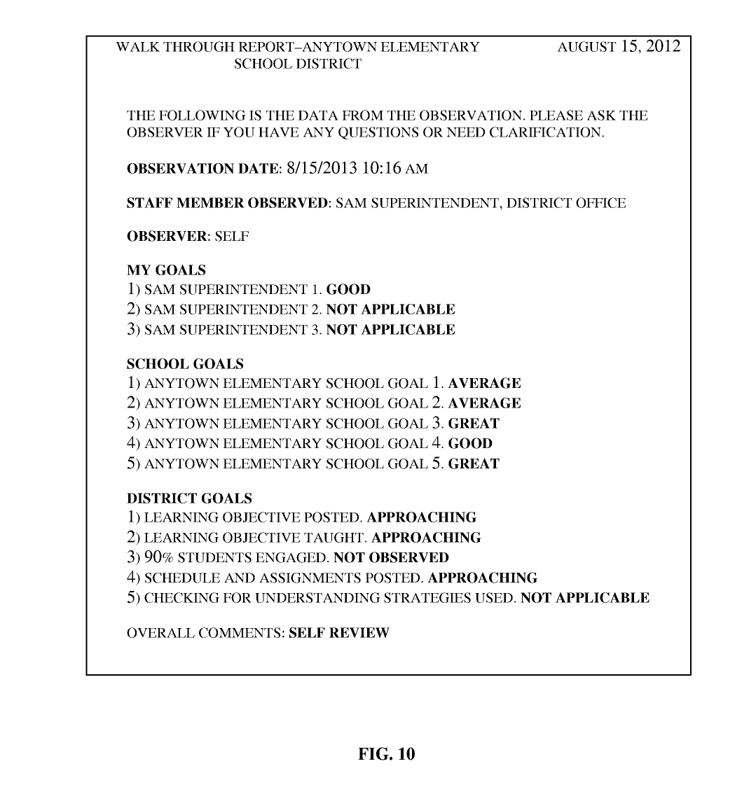

FIG. 10 exemplarily illustrates a progress report of a self review generated by the progress management platform 303 exemplarily illustrated in FIG. 3. The progress management platform 303 displays the progress report of a self review conducted by Sam, the superintendent. Sam perform the self review for goals developed by Sam himself, goals generated by his school, and goals generated by the district to which his school belongs.

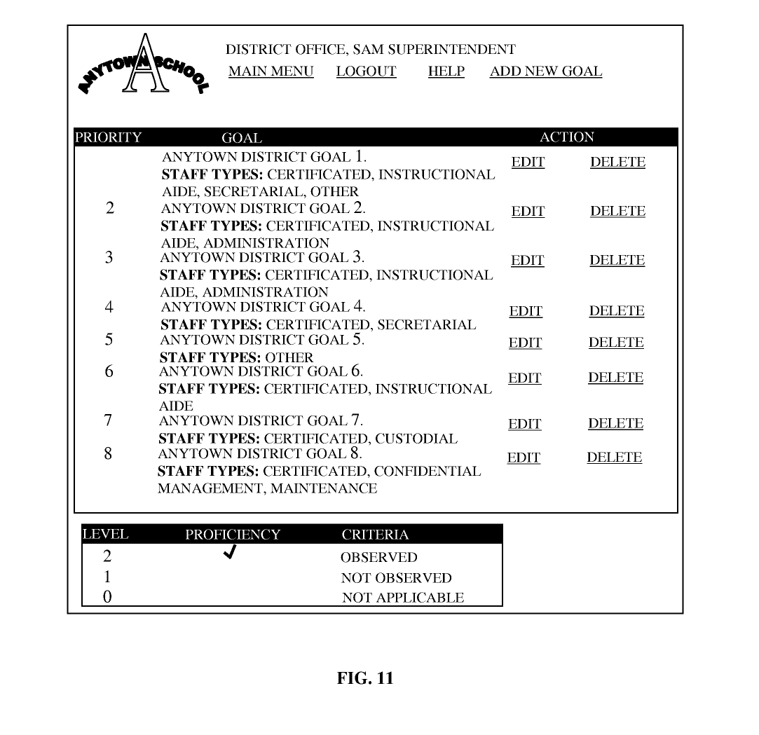

FIG. 11 exemplarily illustrates a screenshot of a performance goal management interface provided by the progress management platform 303 exemplarily illustrated in FIG. 3. The progress management platform 303 enables senior members of the district administrations and the institutions to modify and edit the goal information and the goal criteria based on varying needs and requirements. Consider an example where a senior member of a district administration, for example, as Sam needs to modify certain goal information and goal criteria. The progress management platform 303 allows Sam to modify the goal information and the goal criteria by clicking on options, for example, add a new goal, edit, delete, etc., provided on the performance goal management interface. Accordingly, Sam edits, deletes, or adds new goal information and new goal criteria, and the progress management platform 303 generates new performance goals based on the modifications made by Sam. The progress management platform 303 stores the newly generated performance goals in the advisory repository 303g exemplarily illustrated in FIG. 3.

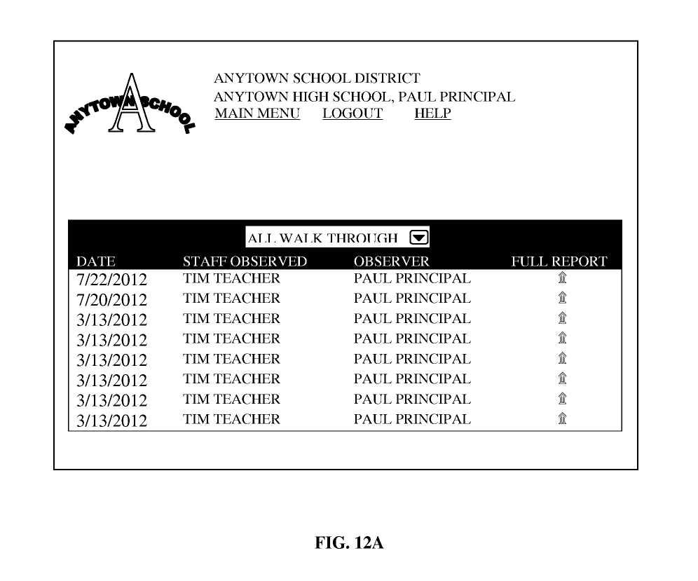

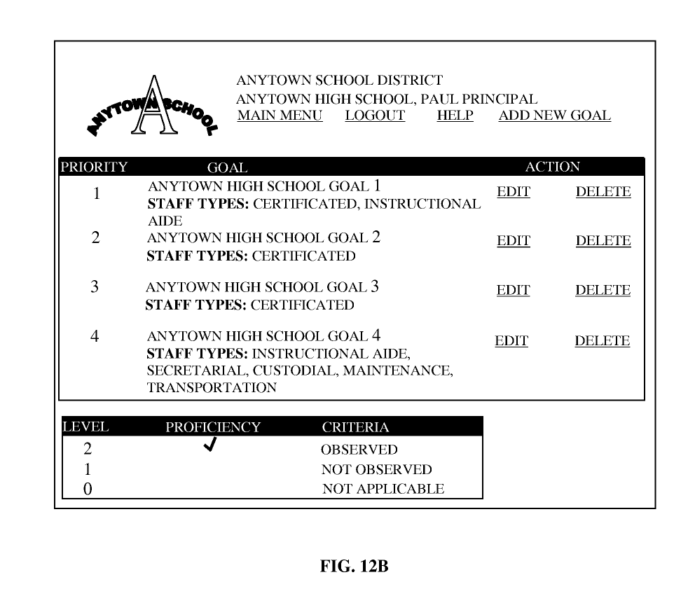

FIGS. 12A-12B exemplarily illustrate screenshots of a graphical user interface (GUI) 303a provided by the progress management platform 303 exemplarily illustrated in FIG. 3, for tracking and managing progress of performance goals by a senior member of an educational institution. Consider an example where Paul, a principal of the educational institution, for example, Anytown high school, develops performance goals for observing the staff members. The progress management platform 303 enables Paul to perform observations on one or more staff members of Anytown high school. FIG. 12A exemplarily illustrates a list of walk through progress reports generated by the progress management platform 303. The generated progress report comprises the entire walk through observations performed by Paul on a teacher Tim. The progress management platform 303 displays the list of dates on which the observations were made, the list of the staff members being observed, the name of the observer, and a link to view the full progress report. The progress report comprises, for example, the observations performed by Paul on a teacher Tim on the date Aug. 22, 2012. The complete progress report includes the comments and inputs provided by the observer, Paul.

The progress management platform 303 also enables the senior members of the institutions to perform observations selectively by choosing, for example, a grade level, a name of a course, a type of the staff member, and the staff to be observed. The progress management platform 303 generates the progress reports related to execution of the performance goals according to the selection made by the senior member.

FIG. 12B exemplarily illustrates a screenshot of a graphical user interface (GUI) 303a provided by the progress management platform 303 exemplarily illustrated in FIG. 3, for modifying and editing performance goals at intervals based on varying needs and requirements of the educational institution. The progress management platform 303 enables Paul, the principal of the educational institution, for example, Anytown high school, to modify, edit, and delete the performance goals. The progress management platform 303 also enables Paul to add new performance goals to the existing performance goals. Once the updated performance goals are submitted by Paul, the progress management platform 303 stores the updated performance goals in the advisory repository 303g exemplarily illustrated in FIG. 3.

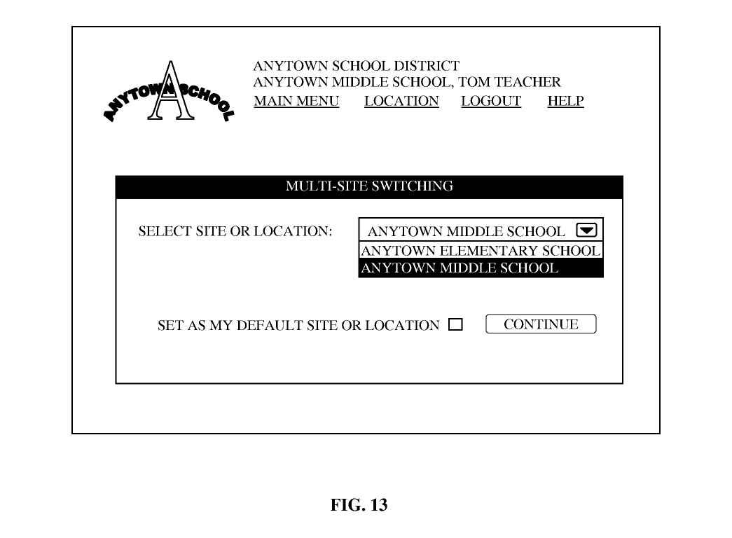

FIG. 13 exemplarily illustrates a screenshot of a graphical user interface (GUI) 303a provided by the progress management platform 303 exemplarily illustrated in FIG. 3, that allows an internal entity to selectively track and manage progress of performance goals across multiple institutions to which the internal entity belongs. Consider an example where an internal entity is employed at two schools, for example, Anytown elementary school and Anytown middle school. The internal entity can switch from one education site of Anytown elementary school to another education site of Anytown middle school on the GUI 303a, which allows the internal entity to have a customized view and isolated data access to data and functions of both sites under a single entity account maintained on the progress management platform 303. The internal entity can therefore track and manage performance goals across the two educational institutions through the single entity account.

FIGS. 14A-14B exemplarily illustrate screenshots of a graphical user interface (GUI) 303a provided by the progress management platform 303 exemplarily illustrated in FIG. 3, for accessing information resources. The GUI 303a displays information resources implemented as resource libraries. The resource library is a menu item for the district level entity accounts, the school level entity accounts, and the staff level entity accounts. The progress management platform 303 allows the staff level entities to only view resources that are uploaded in the resource library by other internal entities subscribed to the progress management platform 303. The district level entities and the school level entities upload documents, spreadsheets, web links, audio links, and video links that are available for the staff level entities to view on an instant feedback report. The resources are attached to both the informal walk through goals and formal observation goals. In an embodiment, the progress management platform 303 provides two types of resource libraries, for example, a district resource library exemplarily illustrated in FIG. 14A, and a school resource library exemplarily illustrated in FIG. 14B. The resource libraries display the details of the information resources, for example, a title, a type, a category, a link to a description, etc., on the GUI 303a. When an internal entity selects the district resource library, the progress management platform 303 prompts the internal entity to select an “add new resource” option from the main menu in order to upload data. The internal entity can then select a format of a data file to be uploaded, for example, a spreadsheet, a document, etc., and a type of web resource, for example, for an audio file, for a video file, for a text file, etc., based on the internal entity's preference. The internal entity then inputs a title and a description for the resource and uploads the resource from a document location of the resource or inputs a web address from which the resource can be uploaded onto the advisory repository 303g. The progress management platform 303 then prompts the internal entity with an “add resource” option to upload the resource link on the advisory repository 303g. The progress management platform 303 displays a list of walk through reports and formal goals to the internal entity from which the internal entity can select which need to be attached to the information resource items. The internal entity then clicks on an “update resource” option. If the internal entity wishes to upload a resource link during a walk through or a formal observation, the internal entity can select an “Attach resource link” of a selected goal on the walk through form or the formal observation form and then select the “submit” option.

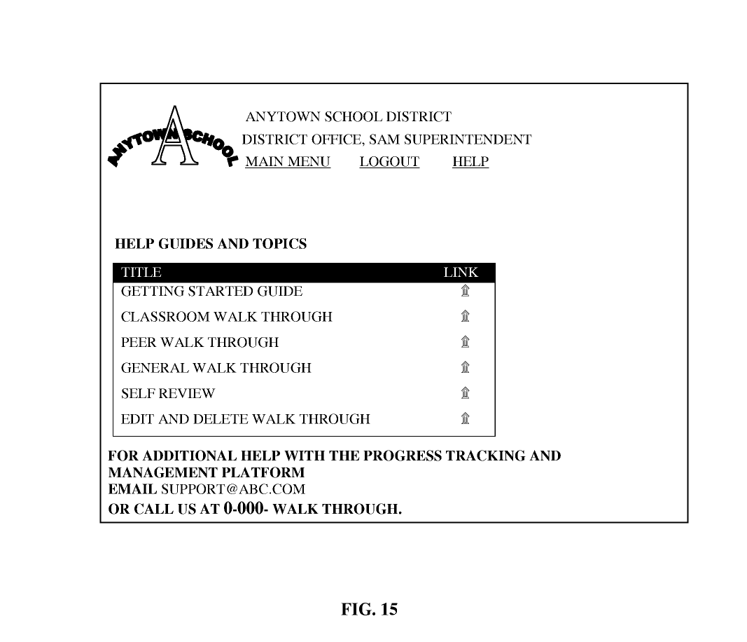

FIG. 15 exemplarily illustrates a screenshot of a graphical user interface (GUI) 303a provided by the progress management platform 303 exemplarily illustrated in FIG. 3, displaying help options provided to internal entities. For example, if Sam requires assistance in performing a peer walk through, he can select a link, for example, for a “peer walk through” provided on the GUI 303a. FIG. 15 exemplarily illustrates a training interface of the progress management platform 303 to assist the internal entities at different levels to use the progress management platform 303 for performing walk throughs, self reviews, modifying walk throughs, etc. The training interface provides links for multiple help guides that can be used by the internal entities. The help guides are, for example, a getting started guide, a classroom walk through guide, a peer walk through guide, a general walk through guide, a self review guide, a guide with instructions on how to edit or delete a walk through, etc. The internal entities can click on a help link provided on the GUI 303a of the progress management platform 303 to access help guides, lodge a support request, or submit a feature request. The progress management platform 303 also provides contact information of a support team of the progress management platform 303 on the GUI 303a to allow the internal entities to reach the support team directly. In an embodiment, the progress management platform 303 also provides training to the internal entities with instructions to use the progress management platform 303. The training covers topics ranging from getting started to implementation of the progress management platform 303, to working with the data stored in the advisory repository 303g. In an embodiment, each training package provided by the progress management platform 303 to the internal entities include information of instructors who can web conference with the internal entities or travel to their facilities to engage with their teams, to ensure that the internal entities at different levels of the institutions or the district administrations have sufficient information about the progress management platform 303 to allow maximization of utilization and benefits of the progress management platform 303 for the internal entities.

Consider an example where a principal of a school wishes to conduct a formal observation of the performance of the internal entities of the school in their respective field of work. The principal subscribes to and logs in to the progress management platform 303 via the network 302. In this example, the progress management platform 303 is a web based platform. Hence, the principal need not download, setup, or install the progress management platform 303 on the principal's entity device 301, thereby providing the principal a simpler, a safer, and a smarter method for accessing the progress management platform 303, than installing the progress management platform 303 on the entity device 301. The progress management platform 303 allows the principal to perform quick and effective walk throughs on the entity device 301, instead of on a piece of paper carried around on a clipboard. The principal walks in to a classroom, accesses the GUI 303a of the progress management platform 303 through the entity device 301 and makes the relevant selections, provides comments, and selects a submit option provided on the GUI 303a for submitting a formal observation to the progress management platform 303. The progress management platform 303 generates a formal progress report based on the data provided by the principal on the formal observation form. Furthermore, the progress management platform 303 transmits the formal progress report directly to the evaluated internal entity, for example, via email to facilitate immediate feedback and saves and archives the formal progress report in the internal entity account of the principal, thereby allowing the principal to review, compare, edit, or print the formal progress report as per the principal's discretion.

Moreover, the principal can add any staff member of the school or import information associated with the staff members from an external resource to the progress management platform 303, thereby providing the added staff members with access to the progress management platform 303. The principal decides which of the added staff members of the school can have access with their own login credentials to the progress management platform 303. The progress management platform 303 provides the principal with easy to configure instructions that allow the principal to set access levels for each of the added staff members. The access levels are, for example, staff type levels comprising an administration level, a school level, a staff level, etc. Moreover, the progress management platform 303 allows the principal to configure settings for email notifications for internal entity accounts of the added staff members. The settings are, for example, manipulating an activation state of the email notifications by turning the email notifications on or off for the internal entity accounts of the added staff members, etc.

In an embodiment, the progress management platform 303 employs a back end support team responsible for securing and performing daily backups of the stored data in the advisory repository 303g, dynamically upgrading the progress management platform 303 with updates provided by application developers of the progress management platform 303, other technical responsibilities associated with the progress management platform 303, etc., and any combination thereof. Hence, the principal need not worry about resolving information technology (IT) related problems encountered by the principal while accessing the progress management platform 303.

It will be readily apparent that the various methods, algorithms, and computer programs disclosed herein may be implemented on computer readable media appropriately programmed for computing devices. As used herein, the term “computer readable media” refers to non-transitory computer readable media that participate in providing data, for example, instructions that may be read by a computer, a processor or a similar device. Non-transitory computer readable media comprise all computer readable media, for example, non-volatile media, volatile media, and transmission media, except for a transitory, propagating signal. Non-volatile media comprise, for example, optical discs or magnetic disks and other persistent memory volatile media including a dynamic random access memory (DRAM), which typically constitutes a main memory. Volatile media comprise, for example, a register memory, a processor cache, a random access memory (RAM), etc. Transmission media comprise, for example, coaxial cables, copper wire, fiber optic cables, modems, etc., including wires that constitute a system bus coupled to a processor, etc. Common forms of computer readable media comprise, for example, a floppy disk, a flexible disk, a hard disk, magnetic tape, a laser disc, a Blu-ray Disc®, any magnetic medium, a compact disc-read only memory (CD-ROM), a digital versatile disc (DVD), any optical medium, a flash memory card, punch cards, paper tape, any other physical medium with patterns of holes, a random access memory (RAM), a programmable read only memory (PROM), an erasable programmable read only memory (EPROM), an electrically erasable programmable read only memory (EEPROM), a flash memory, any other memory chip or cartridge, or any other medium from which a computer can read.

The computer programs that implement the methods and algorithms disclosed herein may be stored and transmitted using a variety of media, for example, the computer readable media in a number of manners. In an embodiment, hard-wired circuitry or custom hardware may be used in place of, or in combination with, software instructions for implementation of the processes of various embodiments. Therefore, the embodiments are not limited to any specific combination of hardware and software. In general, the computer program codes comprising computer executable instructions may be implemented in any programming language. Some examples of programming languages that can be used comprise C, C++, C#, Java®, JavaScript®, Fortran, Ruby, Pascal, Perl®, Python®, Visual Basic®, hypertext preprocessor (PHP), Microsoft® .NET, Cold Fusion®, etc. Other object-oriented, functional, scripting, and/or logical programming languages may also be used. The computer program codes or software programs may be stored on or in one or more mediums as object code. Various aspects of the method and system disclosed herein may be implemented in a non-programmed environment comprising documents created, for example, in a hypertext markup language (HTML), an extensible markup language (XML), or other format that render aspects of a graphical user interface (GUI) or perform other functions, when viewed in a visual area or a window of a browser program. Various aspects of the method and system disclosed herein may be implemented as programmed elements, or non-programmed elements, or any suitable combination thereof. The computer program product disclosed herein comprises computer executable instructions embodied in a non-transitory computer readable storage medium, wherein the computer program product comprises one or more computer program codes for implementing the processes of various embodiments.

Where databases are described such as the advisory repository 303g, it will be understood by one of ordinary skill in the art that (i) alternative database structures to those described may be readily employed, and (ii) other memory structures besides databases may be readily employed. Any illustrations or descriptions of any sample databases disclosed herein are illustrative arrangements for stored representations of information. Any number of other arrangements may be employed besides those suggested by tables illustrated in the drawings or elsewhere. Similarly, any illustrated entries of the databases represent exemplary information only; one of ordinary skill in the art will understand that the number and content of the entries can be different from those disclosed herein. Further, despite any depiction of the databases as tables, other formats including relational databases, object-based models, and/or distributed databases may be used to store and manipulate the data types disclosed herein. Likewise, object methods or behaviors of a database can be used to implement various processes such as those disclosed herein. In addition, the databases may, in a known manner, be stored locally or remotely from a device that accesses data in such a database. In embodiments where there are multiple databases in the system, the databases may be integrated to communicate with each other for enabling simultaneous updates of data linked across the databases, when there are any updates to the data in one of the databases.

The present invention can be configured to work in a network environment comprising one or more computers that are in communication with one or more devices via a network. The computers may communicate with the devices directly or indirectly, via a wired medium or a wireless medium such as the Internet, a local area network (LAN), a wide area network (WAN) or the Ethernet, a token ring, or via any appropriate communications mediums or combination of communications mediums. Each of the devices comprises processors, some examples of which are disclosed above, that are adapted to communicate with the computers. In an embodiment, each of the computers is equipped with a network communication device, for example, a network interface card, a modem, or other network connection device suitable for connecting to a network. Each of the computers and the devices executes an operating system, some examples of which are disclosed above. While the operating system may differ depending on the type of computer, the operating system will continue to provide the appropriate communications protocols to establish communication links with the network. Any number and type of machines may be in communication with the computers.

The present invention is not limited to a particular computer system platform, processor, operating system, or network. One or more aspects of the present invention may be distributed among one or more computer systems, for example, servers configured to provide one or more services to one or more client computers, or to perform a complete task in a distributed system. For example, one or more aspects of the present invention may be performed on a client-server system that comprises components distributed among one or more server systems that perform multiple functions according to various embodiments. These components comprise, for example, executable, intermediate, or interpreted code, which communicate over a network using a communication protocol. The present invention is not limited to be executable on any particular system or group of systems, and is not limited to any particular distributed architecture, network, or communication protocol.

The foregoing examples have been provided merely for the purpose of explanation and are in no way to be construed as limiting of the present invention disclosed herein. While the invention has been described with reference to various embodiments, it is understood that the words, which have been used herein, are words of description and illustration, rather than words of limitation. Further, although the invention has been described herein with reference to particular means, materials, and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may affect numerous modifications thereto and changes may be made without departing from the scope and spirit of the invention in its aspects.

I claim:

1. A computer implemented method for tracking and managing progress of performance goals developed by one or more institutions and one or more district administrations at a plurality of levels, said computer implemented method comprising:
providing a progress management platform comprising at least one processor configured to track and manage said progress of said performance goals, wherein said progress management platform is accessible by internal entities and external entities of said one or more institutions and said one or more district administrations via a network;
receiving goal information and goal criteria at one or more of said levels via a graphical user interface provided by said progress management platform;
generating one or more modifiable performance goals at said one or more of said levels by said progress management platform using said received goal information and said goal criteria;
tracking progress of said generated one or more modifiable performance goals by said progress management platform by collecting and monitoring one or more of observations received on execution of said generated one or more modifiable performance goals by said internal entities at said one or more of said levels, self reviews and peer reviews received from said internal entities at said one or more of said levels, and feedback received from said external entities via said graphical user interface; and
generating one or more progress reports at said one or more of said levels by said progress management platform based on said tracked progress of said generated one or more modifiable performance goals to quantify results of said execution of said generated one or more modifiable performance goals for facilitating accountability, professional development, and development of improvement programs.

2. The computer implemented method of claim 1, further comprising categorizing said generated one or more modifiable performance goals at said one or more of said levels into one of formal goals and informal goals by said progress management platform.

3. The computer implemented method of claim 1, wherein said progress management platform is configured to generate said one or more progress reports based on said categorization of said generated one or more modifiable performance goals at said one or more of said levels into one of formal goals and informal goals.

4. The computer implemented method of claim 1, wherein said progress management platform is configured to generate said one or more progress reports based on one or more of a plurality of source parameters associated with said one or more of said observations received on said execution of said generated one or more modifiable performance goals by said internal entities at said one or more of said levels, said self reviews and said peer reviews received from said internal entities at said one or more of said levels, and said feedback received from said external entities, wherein said source parameters comprise a name of a source of each of said observations, said self reviews, said peer reviews, and said feedback, a staff to which said source belongs, and a frequency of said reception of said observations, said self reviews, said peer reviews, and said feedback.

5. The computer implemented method of claim 1, further comprising generating one or more comparison reports at said one or more of said levels by said progress management platform based on one or more of a plurality of comparison parameters associated with said generated one or more modifiable performance goals, wherein said one or more comparison reports are configured to allow said internal entities at said one or more of said levels of said one or more institutions and said one or more district administrations to analyze said tracked progress of said generated one or more modifiable performance goals for each of said comparison parameters.

6. The computer implemented method of claim 1, further comprising comparing one or more of said observations, said peer reviews, and said feedback received for said internal entities with said self reviews performed by said internal entities by said progress management platform and generating one or more comparison reports by said progress management platform based on said comparison for facilitating said professional development of said internal entities.

7. The computer implemented method of claim 1, further comprising dynamically generating and maintaining an advisory repository by said progress management platform, wherein said advisory repository is configured to store said received goal information, said goal criteria, said generated one or more modifiable performance goals, said received observations, said received self reviews, said received peer reviews, said received feedback, said generated one or more progress reports, and one or more comparison reports, wherein said advisory repository is accessible to said internal entities, said external entities, said one or more institutions, and said one or more district administrations via said network for said development of said improvement programs.

8. The computer implemented method of claim 1, further comprising transmitting one or more of said generated one or more progress reports and one or more comparison reports to one or more of said internal entities at said one or more of said levels by said progress management platform using one or more communication modes over said network.

9. The computer implemented method of claim 1, further comprising establishing one or more professional learning communities by said progress management platform for developing a plurality of pedagogical methods for said professional development, skill acquisition, and skill enhancement of said internal entities at said one or more of said levels at said one or more institutions and said one or more district administrations.

10. The computer implemented method of claim 1, further comprising generating an accreditation score for each of said internal entities by said progress management platform based on an achievement of said generated one or more modifiable performance goals by said internal entities at said one or more of said levels at said one or more institutions and said one or more district administrations.

11. The computer implemented method of claim 1, further comprising creating a single entity account for each of said internal entities at said one or more of said levels of said one or more institutions and said one or more district administrations by said progress management platform, wherein said single entity account is configured to allow said each of said internal entities to track and manage said progress of said generated one or more modifiable performance goals associated with said each of said internal entities across said one or more institutions and said one or more district administrations.

12. The computer implemented method of claim 1, further comprising providing administrative access of internal entity accounts associated with said internal entities to one or more supervising entities at said one or more of said levels of said one or more institutions and said one or more district administrations by said progress management platform for accessing and tracking of said progress of said generated one or more modifiable performance goals of said internal entities at said one or more of said levels of said one or more institutions and said one or more district administrations.

13. The computer implemented method of claim 1, wherein said progress management platform is configured to be compatible with one or more of state government mandated education plans, education development programs, and classroom management tools.

14. The computer implemented method of claim 1, further comprising providing a calendar interface by said progress management platform for scheduling one or more of said development of said improvement programs and a periodic assessment of said internal entities, wherein said progress management platform is configured to dynamically generate alerts to notify said internal entities of one or more of schedules of said one or more of said development of said improvement programs, said periodic assessment of said internal entities, and events of said one or more institutions and said one or more district administrations.

15. The computer implemented method of claim 1, further comprising providing a consultant log-in component to a visiting institution by said progress management platform for collecting information associated with said generated one or more modifiable performance goals and said generated one or more progress reports for said development of said improvement programs at said visiting institution.

16. The computer implemented method of claim 1, further comprising organizing and tracking progress of one or more of interactive student peer groups and interactive instructor-led coaching by said internal entities, by said program management platform at said one or more institutions.

17. The computer implemented method of claim 1, further comprising categorizing said internal entities according to one or more of a plurality of categorization parameters by said program management platform for said development of said improvement programs at said one or more of said levels of said one or more institutions and said one or more district administrations, wherein said categorization parameters comprise skills, qualification, competence, achievements, and said results of said execution of said generated one or more modifiable performance goals of said internal entities.

18. The computer implemented method of claim 1, further comprising performing one or more of a plurality of actions associated with information resources by said progress management platform for said development of said improvement programs, wherein said actions comprise promotion, sale, review, rating, and modification of said information resources.

19. A computer implemented system for tracking and managing progress of performance goals developed by one or more institutions and one or more district administrations at a plurality of levels, said computer implemented system comprising:
a progress management platform accessible by internal entities and external entities of said one or more institutions and said one or more district administrations via a network, said progress management platform comprising:
a non-transitory computer readable storage medium configured to store modules of said progress management platform;
at least one processor communicatively coupled to said non-transitory computer readable storage medium, said at least one processor configured to execute said modules of said progress management platform; and
said modules of said progress management platform comprising:
a data communication module configured to receive goal information and goal criteria at one or more of said levels via a graphical user interface;
a goal generation module configured to generate one or more modifiable performance goals at said one or more of said levels using said received goal information and said goal criteria;
a progress tracking and management module configured to track progress of said generated one or more modifiable performance goals by collecting and monitoring one or more of observations received on execution of said generated one or more modifiable performance goals by said internal entities at said one or more of said levels, self reviews and peer reviews received from said internal entities at said one or more of said levels, and feedback received from said external entities via said graphical user interface; and
a report generation module configured to generate one or more progress reports at said one or more of said levels based on said tracked progress of said generated one or more modifiable performance goals to quantify results of said execution of said generated one or more modifiable performance goals for facilitating accountability, professional development, and development of improvement programs.

20. The computer implemented system of claim 19, wherein said goal generation module is further configured to categorize said generated one or more modifiable performance goals at said one or more of said levels into one of formal goals and informal goals, and wherein said report generation module is further configured to generate said one or more progress reports based on said categorization of said generated one or more modifiable performance goals.

21. The computer implemented system of claim 19, wherein said report generation module is further configured to generate said one or more progress reports based on one or more of a plurality of source parameters associated with said one or more of said observations received on said execution of said generated one or more modifiable performance goals by said internal entities at said one or more of said levels, said self reviews and said peer reviews received from said internal entities at said one or more of said levels, and said feedback received from said external entities, wherein said source parameters comprise a name of a source of each of said observations, said self reviews, said peer reviews, and said feedback, a staff to which said source belongs, and a frequency of said reception of said observations, said self reviews, said peer reviews, and said feedback.

22. The computer implemented system of claim 19, wherein said modules of said progress management platform further comprise a comparison module configured to compare one or more of said observations, said peer reviews, and said feedback received for said internal entities with said self reviews performed by said internal entities for facilitating said professional development of said internal entities, and wherein said report generation module is further configured to generate one or more comparison reports based on said comparison.

23. The computer implemented system of claim 19, wherein said report generation module is further configured to generate one or more comparison reports at said one or more of said levels based on one or more of a plurality of comparison parameters associated with said generated one or more modifiable performance goals, wherein said one or more comparison reports are configured to allow said internal entities at said one or more of said levels of said one or more institutions and said one or more district administrations to analyze said tracked progress of said generated one or more modifiable performance goals for each of said comparison parameters.

24. The computer implemented system of claim 19, wherein said modules of said progress management platform further comprise an advisory repository configured to store said received goal information, said goal criteria, said generated one or more modifiable performance goals, said received observations, said received self reviews, said received peer reviews, said received feedback, said generated one or more progress reports, and one or more comparison reports, wherein said advisory repository is accessible to said internal entities, said external entities, said one or more institutions, and said one or more district administrations via said network for said development of said improvement programs.

25. The computer implemented system of claim 19, wherein said data communication module is further configured to transmit one or more of said generated one or more progress reports and one or more comparison reports to one or more of said internal entities at said one or more of said levels using one or more communication modes over said network.

26. The computer implemented system of claim 19, wherein said progress tracking and management module is further configured to establish one or more professional learning communities for developing a plurality of pedagogical methods for said professional development, skill acquisition, and skill enhancement of said internal entities at said one or more of said levels at said one or more institutions and said one or more district administrations.

27. The computer implemented system of claim 19, wherein said progress tracking and management module is further configured to generate an accreditation score for each of said internal entities based on an achievement of said generated one or more modifiable performance goals by said internal entities at said one or more of said levels at said one or more institutions and said one or more district administrations.

28. The computer implemented system of claim 19, wherein said modules of said progress management platform further comprise an account management module configured to create a single entity account for each of said internal entities at said one or more of said levels of said one or more institutions and said one or more district administrations, wherein said single entity account is configured to allow said each of said internal entities to track and manage said progress of said generated one or more modifiable performance goals associated with said each of said internal entities across said one or more institutions and said one or more district administrations.

29. The computer implemented system of claim 19, wherein said modules of said progress management platform further comprise an account management module configured to provide administrative access of internal entity accounts associated with said internal entities to one or more supervising entities at said one or more of said levels of said one or more institutions and said one or more district administrations for accessing and tracking of said progress of said generated one or more modifiable performance goals of said internal entities at said one or more of said levels of said one or more institutions and said one or more district administrations.

30. The computer implemented system of claim 19, wherein said progress tracking and management module is further configured to categorize said internal entities according to one or more of a plurality of categorization parameters for said development of said improvement programs at said one or more of said levels of said one or more institutions and said one or more district administrations, wherein said categorization parameters comprise skills, qualification, competence, achievements, and said results of said execution of said generated one or more modifiable performance goals of said internal entities.

31. A computer program product comprising a non-transitory computer readable storage medium, said non-transitory computer readable storage medium storing computer program codes that comprise instructions executable by at least one processor, said computer program codes comprising:
a first computer program code for receiving goal information and goal criteria at one or more of a plurality of levels via a graphical user interface;
a second computer program code for generating one or more modifiable performance goals at said one or more of said levels using said received goal information and said goal criteria;
a third computer program code for tracking progress of said generated one or more modifiable performance goals by collecting and monitoring one or more of observations received on execution of said generated one or more modifiable performance goals by internal entities at said one or more of said levels, self reviews and peer reviews received from said internal entities at said one or more of said levels, and feedback received from external entities via said graphical user interface; and
a fourth computer program code for generating one or more progress reports at said one or more of said levels based on said tracked progress of said generated one or more modifiable performance goals to quantify results of said execution of said generated one or more modifiable performance goals for facilitating accountability, professional development, and development of improvement programs.
